(19) United States
(12) Patent Application Publication
(10) Pub. No.: US 2008/0282305 A1
(43) Pub. Date: Nov. 13, 2008

(54) Media Distribution System, Apparatus, Method and Software

(75) Inventors: Thomas A. Uhrig, Dayton, NJ (US); Jaime C. Cummins, Saratoga, CA (US); Nalini P. Uhrig, Dayton, NJ (US)

Correspondence Address: GAMBURD LAW GROUP LLC, 600 WEST JACKSON BLVD., SUITE 625, CHICAGO, IL, 60661, US

(73) Assignee: CARPE MEDIA, Dayton, NJ (US)

(21) Appl. No.: 12/106,316

(22) Filed: Apr. 20, 2008

Related U.S. Application Data
(60) Provisional application No. 60/925,391, filed on Apr. 21, 2007.
(60) Provisional application No. 60/925,517, filed on Apr. 21, 2007.
(60) Provisional application No. 60/925,591, filed on Apr. 21, 2007.

(51) Int. Cl. G06Q 30/00; H04N 7/173

(52) U.S. Cl. 725/114; 705/39

(57) ABSTRACT

Exemplary embodiments of the invention provide for media delivery and reporting. Modules are defined using a an extendable mark up language for first media, second media, and system users. A first module includes characteristics and requirements for first media and second media locations within the first media. A second module includes a second media description and requirements. A third module for each user includes second media preferences and strategies. Corresponding second media is determined for a selected user by searching and matching the second media preferences and strategies with the characteristics and requirements of the first and second modules. Selected first media and the corresponding second media are transmitted in the form of either at least two separate media packet streams, or as a combined first and second media packet stream with the corresponding second media embedded in the first media at least some of the determined second media locations.

### CROSS-REFERENCE TO RELATED APPLICATIONS

This application is related to, a conversion of and claims priority to U.S. Patent Application Ser. No. 60/925,391, filed Apr. 21, 2007, inventors Thomas A. Uhrig et al., entitled “System, Method and Software for Advertising Insertion and Ad and Media Description Language”, which is commonly assigned herewith, the entire contents of which are incorporated herein by reference with the same full force and effect as if set forth in their entirety herein, and with priority claimed for all commonly disclosed subject matter.

This application is related to, a conversion of and claims priority to U.S. Patent Application Ser. No. 60/925,517, filed Apr. 21, 2007, inventors Thomas A. Uhrig et al., entitled “Advertising Inserting Viewer System”, which is commonly assigned herewith, the entire contents of which are incorporated herein by reference with the same full force and effect as if set forth in their entirety herein, and with priority claimed for all commonly disclosed subject matter.

This application is related to, a conversion of and claims priority to U.S. Patent Application Ser. No. 60/925,591, filed Apr. 21, 2007, inventors Thomas A. Uhrig et al., entitled “Advertising Reporting System”, which is commonly assigned herewith, the entire contents of which are incorporated herein by reference with the same full force and effect as if set forth in their entirety herein, and with priority claimed for all commonly disclosed subject matter.

### FIELD OF THE INVENTION

The present invention, in general, relates to distribution, mixing and usage reporting of different types or kinds of media or media content, and more particularly, relates to intelligent and user responsive combining of one or more secondary or second media streams into a primary or first media stream.

### BACKGROUND OF THE INVENTION

Commercial media such as advertising is currently provided to the consumer by including it in a broadcast media stream of other program content or in a static format being distributed to the user. If the digital media requested by the consumer is a video, film, movie, or DVD, an advertisement (“ad”) video is contained in the same format and in line with the program content. If the media requested by the consumer is audio, the advertising audio is contained in the same format and in the same audio stream as the audio program. If the media requested by the consumer is single or multi-page document or website (such as an online newspaper or magazine), the advertisement is embedded in the delivered content at the time of delivery and laid out within delivered pages. In all these cases, the result is the advertisement is fixed and unchanging after delivery. It becomes stale over time; it is not custom-tailored to the consumer other than by the program requested; and if the consumer records the program, the consumer can fast-forward and bypass the advertisement.

These delivery systems do not enable the media consumer to provide their choices and desires and insure that the advertisement is relevant to them, and delivered to them in the format, manner, time, place and device of their choice.

This prior art delivery of media does not give a consumer the flexibility to participate as desired, such as to have selection parameters over advertising types and content, to select such content which would be most relevant or appreciated by them, and the ability to engage the media when it is most convenient for them, such as before the video starts so the video can be played without interruption. In addition, there is no universal applicable media description and packaging available to separately capture each type of media content that includes all their descriptions, characteristics, and their revenue requirements in a universal package that can be used by any distributor or media player, and which can be matched to user preferences.

In addition, a large percentage of the advertising attached to digital media is ineffective because it is indirectly targeted to the consumer, such as when broadcast to all media consumers, or when embedded in particular programs which then have an expected viewer profile. In addition, there is no direct way to determine which advertisements are actually interacted with by the media consumer and how many times they are viewed or otherwise consumed. Rather, the effectiveness of embedded advertising currently being distributed to the consumer is indirectly inferred by the distribution and circulation of the digital program media itself, or by surveys of the viewers (with imperfect memory or lack of interest). For example, after the fact, advertisers of large high-ticket products performs surveys of customers to determine how they selected their products, but this process is costly and does not typically get a uniform sampling across the consumer population. It also does not capture what the consumer was doing with the media and the advertisement, and if they chose to skip over the advertisement.

The result is that advertisers, ad sponsors and ad agencies work with poor-quality, incomplete and out-of-date data when measuring the effectiveness of advertising campaigns and individual ads. These statistical samples may not capture essential information required to accurately gauge the advertising effectiveness or audience reach.

As a consequence, a need remains to provide a system and method for an optimal or near-optimal matching of user preferences and types of media, with user control and input, and with the capability for an accurate assessment of actual, real-time and near real-time media usage and consumption.

### SUMMARY OF THE INVENTION

The exemplary embodiments of the present invention provide a unique mechanism to combine first media, such as a video or an interactive game, with second media, such as an advertisement or an endorsement. For example, an online virtual reality session (as first media) may be combined with a selected implementation of an avatar wearing shirt having a particular logo or holding a particular identifying product (as second media). Also for example, a selected film or video (as first media) may be combined with marketing or advertising media (as second media), such as by interleaving the second media within the first media, by placing the second media periodically within the first media, or by including the second media at the beginning or end of the first media presentation. Of particular importance, the inclusion of such second media (and its locations) is effectively within the control of the user, who may opt out of second media altogether, or who may identify preferred types of second media, or who may do some of each, such as subsidizing use of first media through credits or payments earned by consuming second media, such as by viewing or listening to a particular message.

Also of particular importance, through user preference matching to the requirements of both the first media providers and the second media providers, such providers are able to target particular content to selected consumers, reaching precisely their desired audience for both types of media. Moreover, each provider is able to control or influence the allowed other types of media presented with the provider's media. For example, the producer of a particular first media may prefer that certain types of second media are or are not included with a presentation of the first media, such as to make the first media more appealing to the targeted audience.

As described in greater detail below, the system, methods, apparatuses and software of the present invention utilize a combination of user preferences, first media requirements, and second media requirements, to generate in real time a data stream having combined first and second media, for uses (such as viewing, interacting, or listening) through a media player apparatus. The first media and second media are obtained from corresponding providers, and are pre-processed, to generate corresponding requirements and descriptions which may be readily matched with the user preferences, and to identify locations in the first media for real-time insertion of one or more second media, which may occur locally through a media manager integrated with a media player, or remotely through a media management server. Types of second media are selected based on user preferences, allowing users dominion over their exposure to second media, preferably in areas of interest, further allowing subsidization of their usage of the first media, and further allowing users to opt out of viewing any such second media, though a payment and credit system. Users may also redirect second media to other devices, for use or viewing at other times and in other manners. For example, users may be given the option of paying directly for first media, or redeeming credits from previously viewed second media (stored in their personal profile) and avoiding current viewing of second media, or even viewing extra second media or “micro-payment” second media and building up “micro-payment” credits that can be used for future viewing or redeemed for cash or products. A media manager controls the playing of the first media, and for example, inserts, superimposes, watermarks, overlays, or displays-as-a-banner, selected second media.

The various first and second media stream(s) are buffered to provide for continuity (without skips, jumps, lags, etc.), and the user's media player generally includes a user control input (or remote control) providing start, stop, pause, and forward/reverse operation. The media manager monitors if the user has fast-forwarded and skipped over any second media, and can re-insert the second media (for presentation again to the user), by monitoring view and send pointers.

The integration of user preferences into the usage of first media and second media also provides an accurate mechanism to deliver targeted messages to particular consumer segments, demographics, interest groups, or any other desired category. The exemplary embodiments further provide an accurate assessment and accounting of usage of both first and second media and actual consumer behavior, with corresponding feedback to the providers concerning the effectiveness of their media strategies, such as advertising campaigns, which may then be modified or supplemented, as needed, to generate optimal returns on investment.

Exemplary embodiments of the invention provide a media delivery system comprising: a first media processor adapted to determine a plurality of second media locations within a first media and to determine characteristics and requirements corresponding to the first media; a first media server coupled to the first media processor and adapted to provide a selected first media of a plurality of first media; a first memory coupled to the first media server and the first media processor and adapted to store, for each first media of the plurality of first media, a first module of corresponding characteristics, requirements, and the plurality of second media locations within the first media; a second media processor adapted to determine a second media description and requirements; a second media server adapted to provide a plurality of second media; a second memory coupled to the second media server and the second media processor and adapted to store, for each second media of the plurality of second media, a second module of corresponding characteristics and requirements; a third memory adapted to store, for a plurality of users, a third module of corresponding second media preferences and strategies; a user server coupled to the third memory and adapted to provide, for a selected user of the plurality of users, corresponding second media preferences and strategies; and a media management server couplable to the first media server, the second media server, and the user server, the media manager adapted to determine, using the corresponding second media preferences and strategies of a selected user, corresponding second media, and to provide for a transmission of selected first media and the corresponding second media to a media player of the selected user. The first module, the second module, and the third module may be formatted using a compatible, searchable and extendable mark up language.

The media management server may be further adapted to provide the selected first media as a first media packet stream and to provide separately the corresponding second media as a second media packet stream, or to provide a combined first and second media packet stream comprising the first media and the corresponding second media embedded in the first media at least some of the determined plurality of second media locations. The media management server also may be further adapted to search and match the second media preferences and strategies of the third module to the characteristics and requirements of the first media and the second media of the respective first and second modules.

An exemplary first media processor is further adapted to remove pre-existing second media from the first media, and to determine the plurality of second media locations from scene changes, audio level changes, premarking, and manual marking.

The exemplary system may further comprise a second media reporting server adapted to determine and store, for each user of a plurality of users, corresponding second media viewing, usage or consumption, and the second media reporting server may be further adapted to determine, for each user and for each first or second media provider, corresponding payment, billing, and credit information. The exemplary system may further comprise a media manager adapted to determine playback or fast forwarding of second media by comparing a view pointer location and a send pointer location.

Another exemplary embodiment provides a tangible medium storing computer-readable and executable software instructions, comprising: a first program construct adapted to determine and store as a corresponding first module, for each first media of a plurality of first media, a plurality of second media locations within the first media and characteristics and requirements corresponding to the first media; a second program construct adapted to determine and store as a corresponding second module, for each second media of a plurality of second media, a second media description and requirements; a third program construct adapted to determine and store as a corresponding third module, for each user of a plurality of users, corresponding second media preferences and strategies; and a fourth program construct adapted to determine, using the corresponding second media preferences and strategies of a selected user, corresponding second media, and to provide for a transmission of a selected first media and the corresponding second media.

The fourth program construct may be further adapted to provide the selected first media as a first media packet stream and to provide separately the corresponding second media as a second media packet stream, and is further adapted to provide a combined first and second media packet stream comprising the first media and the corresponding second media embedded in the first media at least some of the determined plurality of second media locations. The fourth program construct may be further adapted to search and match the second media preferences and strategies of the third module to the characteristics and requirements of the first media and the second media of the respective first and second modules.

The first program construct may be further adapted to remove pre-existing second media from the first media and to determine the plurality of second media locations from scene changes, audio level changes, premarking, and manual marking.

The exemplary tangible medium storing computer-readable and executable software instructions may further comprise a fifth program construct adapted to determine and store, for each user of a plurality of users, corresponding second media viewing, usage or consumption, and a sixth program construct adapted to determine, for each user and for each first or second media provider, corresponding payment, billing, and credit information.

A media delivery apparatus is also provided, in which the apparatus is couplable to a plurality of storage devices having a corresponding plurality of databases, a first database storing for each first media of the plurality of first media a corresponding first module of characteristics, requirements, and a plurality of second media locations within the first media, a second database storing a corresponding second module of characteristics and requirements for each second media of a plurality of second media, and a third database storing a third module of corresponding second media preferences and strategies for each user of a plurality of users. The exemplary apparatus comprises: a communication interface; a memory; and a processor coupled to the memory and to the communication interface, the processor adapted to determine, using the corresponding second media preferences and strategies of a selected user, corresponding second media, and to provide for a transmission to a media player of the selected user of a combined first and second media packet stream comprising selected first media and the corresponding second media embedded in the selected first media at least some of the determined plurality of second media locations.

Another exemplary embodiment provides a media delivery and reporting method, comprising: determining and storing as a corresponding first module, for each first media of a plurality of first media, a plurality of second media locations within the first media and characteristics and requirements corresponding to the first media; determining and storing as a corresponding second module, for each second media of a plurality of second media, a second media description and requirements; determining and storing as a corresponding third module, for each user of a plurality of users, corresponding second media preferences and strategies; formatting the first module, the second module, and the third module using a compatible, searchable and extendable mark up language; determining corresponding second media for a selected user by searching and matching the second media preferences and strategies of the third module corresponding to the selected user to the characteristics and requirements of the first media and the second media of the respective first and second modules; and transmitting selected first media and the corresponding second media in the form of either at least two separate media packet streams, or as a combined first and second media packet stream comprising the first media and the corresponding second media embedded in the first media at least some of the determined plurality of second media locations. The method may further include determining and storing, for each user of a plurality of users, corresponding second media viewing, usage or consumption, and determining and storing, for each user and for each first or second media provider, corresponding payment, billing, and credit information.

Another exemplary embodiment provides a media player apparatus, comprising: a user control input; a memory storing a view pointer; a player buffer; a user preference controller adapted to receive input from the user control input and to locate first media; and a second media controller adapted to identify a plurality of second media locations within a first media and to insert selected second media into corresponding locations of the first media during playback.

The exemplary second media controller may be further adapted to monitor playback of the first media and a plurality of second media, such as by determining and storing a send pointer and comparing the send pointer with the view pointer to determine a playback discontinuity. The second media controller may be further adapted to insert another selected second media into the first media upon detection of a fast-forward playback discontinuity, or to omit the selected second media from its corresponding location in the first media upon detection of a reverse or rewind playback discontinuity.

The exemplary second media controller may be further adapted to transmit data to a reporting server, the data comprising a user identification, an identification of the inserted plurality of second media, an identification of the first media, a date, a time, any user payment amount for the first media.

The exemplary user preference controller may be further adapted to determine user preferences for the plurality of second media, and to determine user strategies for the plurality of second media locations and for first media payment.

The exemplary apparatus may be embodied as a personal computer storing executable media player instructions; or may be distributed, with the user control input, the memory storing a view pointer and the player buffer embodied on a personal computer, and wherein the user preference controller and the second media controller are embodied on a server couplable through a network to the personal computer.

An exemplary embodiment also provides a media playing method, comprising: locating first media, the first media having identifications of a plurality of potential second media locations; using user preferences, selecting a plurality of second media; inserting the plurality of second media into at least some of the identified plurality of potential second media locations; and playing the first media having the inserted plurality of second media. The exemplary method may also include monitoring playback of the first media and a plurality of second media, such as comparing a send pointer with a view pointer to determine a playback discontinuity, and inserting another selected second media into the first media upon detection of a fast-forward playback discontinuity, or omitting the selected second media from its corresponding location in the first media upon detection of a reverse or rewind playback discontinuity.

The exemplary method may also include transmitting data to a reporting server, the data comprising a user identification, an identification of the inserted plurality of second media, an identification of the first media, a date, a time, any user payment amount for the first media. The various methods may also provide for determining user preferences for the plurality of second media, and determining user strategies for the plurality of second media locations and for first media payment.

Another exemplary embodiment provides a tangible medium storing computer-readable and executable software instructions, comprising: a first program construct adapted to locate first media, the first media having identifications of a plurality of potential second media locations; a second program construct adapted to use user preferences to select a plurality of second media; a third program construct adapted to insert the plurality of second media into at least some of the identified plurality of potential second media locations; a fourth program construct adapted to play the first media having the inserted plurality of second media; and a fifth program construct adapted to monitor the playback of the first media and a plurality of second media, and to insert another selected second media into the first media upon detection of a fast-forward playback discontinuity. The tangible medium storing computer-readable and executable software instructions may also include a sixth program construct adapted to transmit data to a reporting server, the data comprising a user identification, an identification of the inserted plurality of second media, an identification of the first media, a date, a time, any user payment amount for the first media.

An exemplary media distribution reporting system is also provided, in which the system is couplable through a network to a plurality of media players. The exemplary system embodiment comprises: a memory storing a database having media usage data; and a second media reporting server, the second media reporting server coupled to the memory and adapted to receive from each media player, of the plurality of media players, corresponding data comprising a user identification, an identification of first media, an identification of a plurality of second media inserted into the first media, a date, a time, any user payment amount for the first media; the second media reporting server further adapted to combine the corresponding data from the plurality of media players to generate the media usage data; and the second media reporting server further adapted to generate a plurality of media usage reports for allocation of revenue and payment among a plurality of users, first media providers, and second media providers.

The exemplary second media reporting server may be further adapted to determine and report user preferences for the plurality of second media; to determine and report user strategies for playback of the plurality of second media; to generate media usage data which further comprises user demographic information; to generate media usage data which further comprises corresponding descriptions of the first media and the plurality of second media; or to generate media usage data which further comprises corresponding revenue generation requirements of the first media and the plurality of second media.

An exemplary media distribution reporting method comprises: receiving from each media player, of a plurality of media players, corresponding data comprising a user identification, an identification of first media, an identification of a plurality of second media inserted into the first media, a date, a time, any user payment amount for the first media; combining the corresponding data from the plurality of media players to generate media usage data for each first media of a plurality of first media; combining the corresponding data from the plurality of media players to generate media usage data for each second media of a plurality of second media; and generating a plurality of media usage reports for allocation of revenue and payment among a plurality of users, first media providers, and second media providers.

A tangible medium storing computer-readable and executable software instructions is also disclosed, comprising: a first program construct adapted to receive from each media player, of a plurality of media players, corresponding data comprising a user identification, an identification of first media, an identification of a plurality of second media inserted into the first media, a date, a time, any user payment amount for the first media; a second program construct adapted to combine the corresponding data from the plurality of media players to generate media usage data for each first media of a plurality of first media; a third program construct adapted to combine the corresponding data from the plurality of media players to generate media usage data for each second media of a plurality of second media; and a fourth program construct adapted to generate a plurality of media usage reports for allocation of revenue and payment among a plurality of users, first media providers, and second media providers. Additional program constructs may also be provided, which may be adapted to determine and report user preferences for the plurality of second media; to determine and report user strategies for playback of the plurality of second media; to generate media usage data which further comprises user demographic information; to generate media usage data which further comprises corresponding descriptions of the first media and the plurality of second media; or to generate media usage data which further comprises corresponding revenue generation requirements of the first media and the plurality of second media.

These and additional embodiments are discussed in greater detail below. Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a block diagram illustrating a first exemplary system embodiment in accordance with the teachings of the present invention.

FIG. 2 is a block diagram illustrating a first exemplary apparatus embodiment in accordance with the teachings of the present invention.

FIG. 3 is a block diagram illustrating in greater detail exemplary apparatus embodiments for a first media processor node and a first media server in accordance with the teachings of the present invention.

FIG. 4 is a block diagram illustrating in greater detail exemplary apparatus embodiments for a second media processor node and a second media server in accordance with the teachings of the present invention.

FIG. 5 is a block diagram illustrating in greater detail exemplary apparatus embodiments for a media manager apparatus and second media reporter in accordance with the teachings of the present invention.

FIG. 6 is a block diagram illustrating in greater detail an exemplary media viewer or player apparatus in accordance with the teachings of the present invention.

FIG. 7 is a flow diagram illustrating generation of a media description language description for first media in accordance with the teachings of the present invention.

FIG. 8 is a flow diagram illustrating generation of a media description language description for second media in accordance with the teachings of the present invention.

FIG. 9 is a flow diagram illustrating generation of a media description language description for input of user data through a media player apparatus in accordance with the teachings of the present invention.

FIG. 10, divided into FIGS. 10A and 10B, is a flow diagram illustrating exemplary operation of a media player apparatus in accordance with the teachings of the present invention.

FIG. 11 is a block diagram illustrating a second media reporting system in accordance with the teachings of the present invention.

FIG. 12 is a flow diagram illustrating second media reporting in accordance with the teachings of the present invention.

### DETAILED DESCRIPTION OF EXEMPLARY EMBODIMENTS

While the present invention is susceptible of embodiment in many different forms, there are shown in the drawings and will be described herein in detail specific exemplary embodiments thereof, with the understanding that the present disclosure is to be considered as an exemplification of the principles of the invention and is not intended to limit the invention to the specific embodiments illustrated. In this respect, before explaining at least one embodiment consistent with the present invention in detail, it is to be understood that the invention is not limited in its application to the details of construction and to the arrangements of components set forth above and below, illustrated in the drawings, or as described in the examples. Systems, methods, software and apparatuses consistent with the present invention are capable of other embodiments and of being practiced and carried out in various ways. Also, it is to be understood that the phraseology and terminology employed herein, as well as the abstract included below, are for the purposes of description and should not be regarded as limiting.

For example, although the following description is made in the context of a specific implementation, those skilled in the art will recognize that the method, software, apparatus and system disclosed herein apply equally to other media and advertising packaging formats and system implementations. Moreover, the descriptions use the terminology of an exemplary video program to be delivered over the Internet; however, the methods and system disclosed herein applies to other delivery means (even distribution using physical exchange media such as CDs and DVDs) and to other media formats of audio, paged documents, e-magazines, web pages, audio or music players, video games, virtual reality applications, mobile navigation systems or any other media application. Continuing with the example, one embodiment may consist of a video as the primary media stream with a sequence of advertisements (“ads”) as a plurality of secondary media streams, while another embodiment may consist of an online game or virtual reality entertainment as the primary media stream with virtual player (e.g., avatar) clothing having an embedded endorsement as the secondary media stream. The scope of the present invention includes any type of media, such as video, audio, text, multimedia, mixed media, 3D graphics, radio, navigation data, etc., currently known or which may be developed in the future, and further, which may be static or dynamic.

In addition, the primary and secondary media streams may be combined before or after transmission to the user. The resulting, combined media stream is then available for viewing, playing, listening, etc., by the user in real-time, near real-time, or non real-time.

Exemplary embodiments of the systems, apparatus and methods of the invention also enable, in real-time, the selection of the second media based on the combined preferences of the media user's preferences, the first media owner's preferences, and the advertiser's preferences. In addition, all of these preferences may be changed dynamically.

Various advantages of the present invention include use of a media description language (“MDL”) that separately captures first media and second media, that includes all their descriptions, characteristics, placement, and their revenue producing requirements within a universal package useable by any distributor or media player. The inventive MDL further captures user preferences, including media preferences, such as for types of media, and media delivery preferences, such as the time, device, manner and placement of delivery. The packaging is structured and contains all the information needed to match users and their preferences to the media and deliver the media to the users, such that all the desires, likes and preferences of users and requirements of media providers are taken into consideration. In addition, the potential placement opportunities for second media identified, and generally only a subset of these are used, as the user is given the option of choosing second media placement, format type, destination device, time deferral, or second media re-direction, and the strategy of placing these within the first media. The inventive media description language is structured to be extensible, so additional fields and parameters can be added without changing the structure of the modules generated, their input and output functionality and interactions with other routines, or the subroutines used to perform various levels and types matching.

The various embodiments further provide for modification of the media itself, to now include new images, video, audio, graphics or mixed media that did not exist before, or to provide dynamic replacement of such pre-existing images or other content in the media, prior to its use by the consumer. The exemplary embodiments further provide for descriptions of the behaviors of the media, such as a media agent or ad object, in a static or dynamic manner.

Exemplary embodiments also provide for displacement in time, place and manner of the various first and second media, such as enabling a time delay of second media delivery to the media consumer, and a method to record that this occurred and record the time and place of the deferred second media consumption.

Additional advantages of the exemplary systems, apparatus and methods include capturing the statistics of the actual first and second media, and the profile of the media user, including the user's actions and behaviors. In addition, the data may be collected on-line in real time, so the reported media statistics can be almost instantaneous, providing a new and unique method of measuring and optimizing media effectiveness, and for targeted specific audiences to any desired breadth.

Yet additional advantages of the exemplary systems, apparatus and methods include user empowerment, resulting in greater user satisfaction. For example, a user may select desired types and content of second media, timing, manner, and placement of second media, or opt out of second media altogether, or receive payments (micro-payments) or build credits for consuming second media, which may be redeemable for cash, products, or future media consumption, or control the number, placement, type, time, device, and delivery format of the second media. Numerous other advantages will also be readily apparent to those having skill in the art.

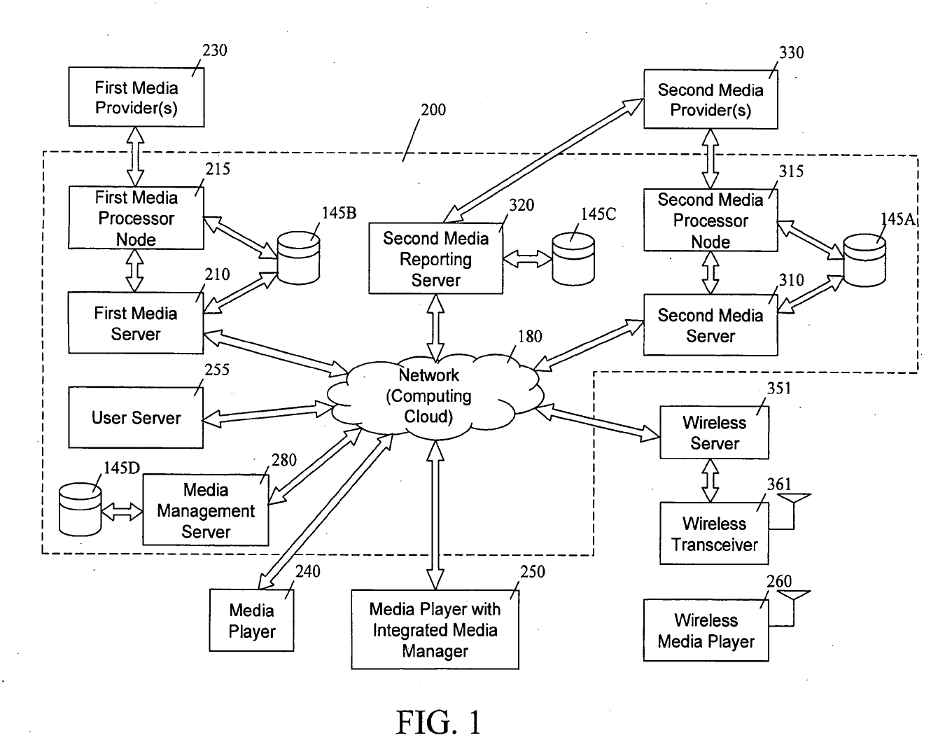

FIG. 1 is a block diagram illustrating a first exemplary system embodiment 200 in accordance with the present invention, with exemplary processing nodes (215, 315), server nodes (210, 255, 280, 310, 320), and with exemplary file and/or database systems 145, illustrated as file and/or database systems 145A, 145B, 145C and 145D, any of which may be located locally or remotely, from each other and from the network (or computing cloud) 180. Such one or more processing nodes (215, 315), server nodes (210, 255, 280, 310, 320), and file and/or database systems 145 may be programmed, adapted or configured with software, program or other computer instructions or configuration information or metadata to operate in accordance with the teachings of the present invention, as discussed below.

As illustrated, the system 200 comprises a primary media stream server 210, a primary media stream processor node 215, a user (or viewer) server (or node) 255, a media management server 280, a secondary media stream server 310, a secondary media stream processor node 315, a secondary media stream reporting server 320, and one or more databases (or other forms of memory or data storage, as described below) 145. Any or all of these may also be provided from one or more local or remote locations. In addition, as illustrated in FIG. 1, the various servers or nodes may also be embodied as networks. Accordingly, any reference to servers, nodes, etc. should be understood to mean and include other embodiments, such as network or other distributed embodiments. In addition, in various exemplary embodiments, instead of being included separately within the system 200, the media management server 280 or its various components such as a media manager 275 may be embodied directly within or otherwise integrated into a media player, such as the media player with integrated manager 250.

All of the various servers or networks (210, 255, 280, 310, and 320) and processing nodes or networks (215 and 315) are adapted to communicate with each other and with other server and communication equipment (e.g., wireless server 351, wireless transceiver 361) and various end-user communication or display devices such as the illustrated media players 240, 250 and 260, via network (or cloud) 180. Network 180 may be any type or form of communication network, such as the Internet, a public switched telephone network (“PSTN”) (typically utilized for circuit-switched voice and data transmission), a cable network, any packet or digital network, or local or wide-area wired or wireless networks, such as IEEE 802.11 and/or Bluetooth networks, for example.

As illustrated, the various servers or networks (210, 255, 280, 310, and 320) and processing nodes or networks (215 and 315) may also be included within or coupled to a larger data communication network 180, for full duplex communication with remote devices, such as a remote servers, remote computers (or other terminals), and the media players 240, 250 and 260. Such remote communication capability provides for the system (200) to be accessible for on-line functionality, discussed in greater detail below, such as for web-based access, using any current or future protocols, such as hypertext transfer protocol (“HTTP”), various email and file transfer protocols (e.g., SMTP, FTP), Transmission Control Protocol (“TCP”), Internet Protocol (“IP”), or any other forms of communication for data, voice or multimedia, for user input, selection, evaluation, reporting, media provision, and so on, discussed below. The various media players 240, 250 and 260 also implement forms of user control nodes, may be implemented as known or becomes known in the art, such as through a personal computer, a client-server embodiment, a data terminal, a television, for example, typically having a monitor for display of information, such as a video display or computer monitor, and having data input means, such as a remote control, keyboard, pointing device (e.g., mouse, trackball, touch pad), joystick, scanner, touch screen, microphone, voice recognition system, keypad, and so on.

The primary (or first) media stream and the secondary (or second) media stream(s) may be any type of media, in any form or format. While each will typically have a digital format and will be transmitted or stored as a sequence of data packets, other media formats are also within the scope of the present invention, including static formats. In addition, the primary media stream and secondary media stream also may include static or less dynamic elements as well, such as a stored or displayed media framework or image, which then may include dynamically changing embedded media elements, such as is often the case for the display of web pages. For purposes of the present invention, all that is required is that there is a first or primary media, for viewing, listening, interacting, transmission, or storage, into which a second or secondary media will be inserted or otherwise combined, in any desired or selected pattern. This combining may occur locally to the user, within a media player 250, or remotely from the user, by a media management server 280. For example, the second media may be interleaved with the first media, the second media may be inserted at the beginning, middle or end of the first media, or the second media may be diverted or redirected, such as for viewing on a secondary device or viewing at another time or place. In addition, this may occur within the system 200 in real-time, near-real-time and/or non-real-time, with any type of digital media.

For example, when the second media comprises one or more advertisements, mixing, combining or inserting with the first media may include being embedded or interleaved with the first media, being displaced from the first media (meaning delivered at a different time, place or manner than the first media), being redirected (meaning delivered in a different time, place or manner to another device than the one to which the first media is being delivered), being interactive (second media distinct from the first media and with which the media consumer or user directly interacts). As another example, the system 200 can also be used to place second media such as endorsements, graphics, audio, marketing materials or other advertisements into virtual worlds as static ads, dynamic ads, video or audio or text or graphic ads, or ads that comprise an avatar in a virtual world with defined behaviors and actions when encountered that can be personalized to the media consumer.

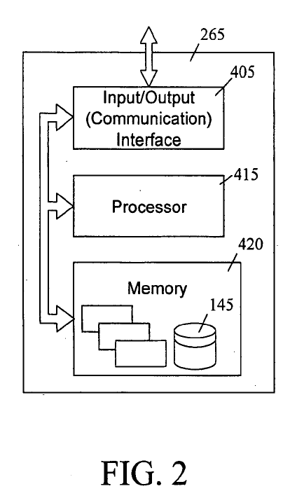

The operation of the system 200 will be described in greater detail with reference to FIGS. 2-12.

Referring to FIG. 2, which is a block diagram illustrating a first exemplary apparatus 265 embodiment in accordance with the teachings of the present invention. The first exemplary apparatus 265 comprises an input and output (I/O) interface 405, one or more processors 415, and a memory 420 storing any type of data (such as one or more databases or file systems (individually and collectively referred to as data repositories) 145). Any or all of the various servers or networks (210, 255, 280, 310, and 320), processing nodes or networks (215 and 315), and media players 240, 250 and 260 may be implemented or embodied as a first exemplary apparatus 265 which, for example, may be forms of computer systems (e.g., a mainframe computer, a personal computer, a computer workstation, server, or any other computer or device having processing power sufficient to execute the exemplary methods of the invention).

The database 145 may be integrated, namely, that the information resides within a singular, co-located or otherwise centralized database structure or schema, or may be a distributed database, with information distributed between and among a plurality of databases, some of which may be remotely located from the other databases. (A “data repository”, “database”, and “data warehouse”, as used herein, are considered interchangeable, and may be relational, object-oriented, object-relational, or use files or flat files, or any combinations of the above. Databases 145A, 145B, 145C, 145D are instantiations of one or more databases, data warehouses, or data cubes, discussed in greater detail below. Reference to a “data cube” will be understood to mean a particular multidimensional instantiation of such a database 145, adapted in advance through an aggregation process for particularly responsive query processing, and which typically will have a plurality of different views which may be materialized (e.g., a lattice of views).)

A “processor” 415 (or 470, or controller 425, 445) may be any type of controller, processor, accelerator, and may be embodied as one or more processors 415 (or 470, or controller 425, 445), adapted to perform the functionality discussed herein. As the term processor or controller is used herein, a processor 415 may include use of a single integrated circuit (“IC”), or may include use of a plurality of integrated circuits or other components connected, arranged or grouped together, such as controllers, microprocessors, digital signal processors (“DSPs”), accelerators, parallel processors, multiple core processors, custom ICs, application specific integrated circuits (“ASICs”), field programmable gate arrays (“FPGAs”), adaptive computing ICs, associated memory (such as RAM, DRAM and ROM), and other ICs and components. As a consequence, as used herein, the term processor or controller should be understood to equivalently mean and include a single IC, or arrangement of custom ICs, ASICs, processors, microprocessors, controllers, FPGAs, adaptive computing ICs, or some other grouping of integrated circuits which perform the functions discussed below, with associated memory, such as microprocessor memory or additional RAM, DRAM, SDRAM, SRAM, MRAM, ROM, FLASH, EPROM or E2PROM. A processor (such as processor 415), with its associated memory, may be adapted or configured (via programming, FPGA interconnection, or hard-wiring) to perform the methodologies of the invention. For example, the methodology may be programmed and stored, in a processor 415 with its associated memory (and/or memory 420) and other equivalent components, as a set of program instructions or other code (or equivalent configuration or other program) for subsequent execution when the processor is operative (i.e., powered on and functioning). Equivalently, when the processor 415 may implemented in whole or part as FPGAs, custom ICs and/or ASICs, the FPGAs, custom ICs or ASICs also may be designed, configured and/or hard-wired to implement the methodology of the invention. For example, the processor 415 may be implemented as an arrangement of processors, controllers, microprocessors, DSPs, fully custom accelerators and/or ASICs, collectively referred to as a “controller” or “processor”, which are respectively programmed, designed, adapted or configured to implement the methodology of the invention, in conjunction with a memory 420.

The memory 420, which may include a data repository (or database) 145, may be embodied in any number of forms, including within any computer or other machine-readable data storage medium, memory device or other storage or communication device for storage or communication of information, currently known or which becomes available in the future, including, but not limited to, a memory integrated circuit (“IC”), or memory portion of an integrated circuit (such as the resident memory within a processor 415), whether volatile or non-volatile, whether removable or non-removable, including without limitation RAM, FLASH, DRAM, SDRAM, SRAM, MRAM, FeRAM, ROM, EPROM or E2PROM, or any other form of memory device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, which is known or which becomes known, depending upon the selected embodiment. In addition, such computer readable media includes, as an article of manufacture, any form of tangible communication media which embodies computer readable instructions, data structures, program modules or other data in a data signal or modulated signal, including any tangible information delivery media, which may encode data or other information. The memory 420 may be adapted to store various look up tables, parameters, coefficients, other information and data, programs or instructions (of the software of the present invention), and other types of tables such as database tables.

As indicated above, the processor 415 may be programmed, using software and data structures of the invention, or configured using configuration information, for example, to perform the methodology of the present invention. (In other embodiments, the processor 415 may be hardwired to perform the methodology of the present invention, such as when embodied as one or more ASICs or accelerators.) As a consequence, the system and method of the present invention may be embodied as software which provides such programming or other instructions, such as a set of instructions and/or metadata embodied within a tangible, computer readable medium. In addition, metadata may also be utilized to define the various data structures of a look up table or a database. Such software may be in the form of source or object code, by way of example and without limitation. Source code further may be compiled into some form of instructions or object code (including assembly language instructions or configuration information). The software, source code or metadata of the present invention may be embodied as any type of code, such as C, C++, SystemC, LISA, XML, PHP, Ruby, Perl, Java, Brew, any scripting language, SQL and its variations (e.g., SQL 99 or proprietary versions of SQL), DB2, Oracle, or any other type of programming language which performs the functionality discussed herein, including various hardware definition or hardware modeling languages (e.g., Verilog, VHDL, RTL) and resulting database files (e.g., GDSII). As a consequence, a “construct”, “program construct”, “software construct” or “software”, as used equivalently herein, means and refers to any programming language, of any kind, with any syntax or signatures, which provides or can be interpreted to provide the associated functionality or methodology specified (when instantiated or loaded into a processor or computer and executed, including the processor 415, for example).

The software, metadata, or other source code of the present invention and any resulting bit file (object code, database, or look up table) may be embodied within any tangible storage medium, such as any of the computer or other machine-readable data storage media, as computer-readable instructions, data structures, program modules or other data, such as discussed above with respect to the memory 420, e.g., FLASH ICs, a floppy disk, a CDROM, a CD-RW, a DVD, a magnetic hard drive, an optical drive, or any other type of data storage apparatus or medium, as mentioned above.

The I/O interface 405 may be implemented as known or may become known in the art, to provide data communication between the processor 415 and the network 180, using any applicable standard (e.g., one of the various PCI, USB or Ethernet standards, for example and without limitation, and may include impedance matching capability, voltage translation for a low voltage processor to interface with a higher voltage control bus, and various switching mechanisms (e.g., transistors) to turn various lines or connectors on or off in response to signaling from the processor 415. In addition, the I/O interface 405 may also be adapted to receive and/or transmit signals externally to the system 200, such as through hard-wiring or RF signaling, for example, to receive information in real-time to control a dynamic display or media players 240, 250 and 260, for example. The I/O interface 405 may provide connection to any type of bus or network structure or medium, using any selected architecture. By way of example and not limitation, such architectures include Industry Standard Architecture (ISA) bus, Enhanced ISA (EISA) bus, Micro Channel Architecture (MCA) bus, Peripheral Component Interconnect (PCI) bus, SAN bus, or any other communication or signaling medium, such as Ethernet, ISDN, Ti, satellite, wireless, and so on.

In addition to the configuration illustrated in FIG. 2, those of skill in the art will recognize that there are innumerable equivalent configurations, layouts, kinds and types of control, interface, and memory circuitry known in the art, which are within the scope of the present invention.

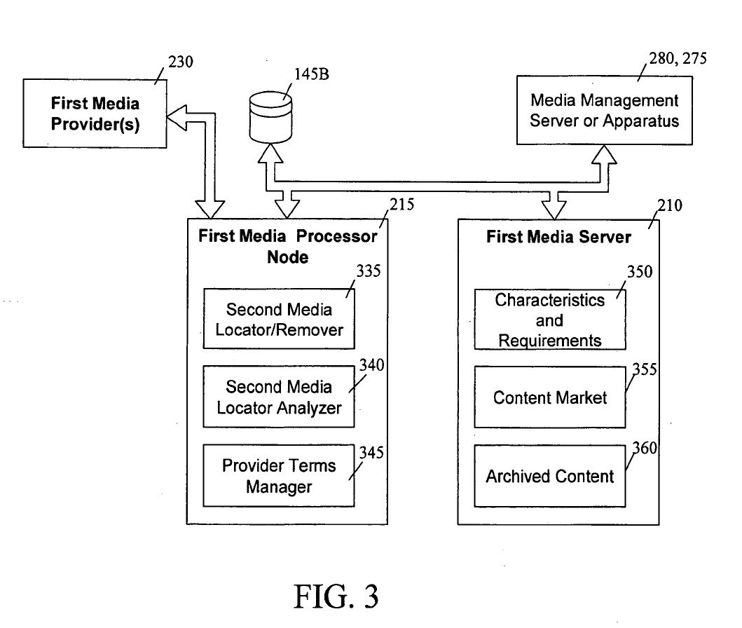

FIG. 3 is a block diagram illustrating in greater detail exemplary apparatus embodiments for a first media processor node 215 and a first media server 210 in accordance with the teachings of the present invention. A first media provider 230, such as a video or audio provider, provides the first media, which is received by the first media processor node 215. Processing the first media, the first media processor node 215 locates and strips or otherwise removes any pre-existing second media (in the second media locator and remover 335), such as ads, and determines one or more locations for insertion of second media (in the second media location analyzer 340). Existing locations for second media may be utilized, and new locations may be identified, such as from scene changes, breaks in the program, audio changes, etc. The selected locations are identified or catalogued (and typically tagged, as described below), and incorporated into a second media location list in the MDL header for the first media. The first media processor node 215 also utilizes a provider terms manager 345, which provides information utilized in other parts of the system 200, such as for determining an amount and type of second media for mixing with the first media. The first media processor node 215 then prepares the first media for distribution, such as by using the media description language (MDL) of the present invention, and provides it to and stores it in the first media server 210, as a characteristics and requirements module 350, a content market module 355, and an archived content module 360, which may be in the form of a database or a flat file, for example. The first media server 210 is then adapted or configured to provide any such first media, from any first media provider, in the form of a primary media stream to a media management apparatus 275 or media management server 280.

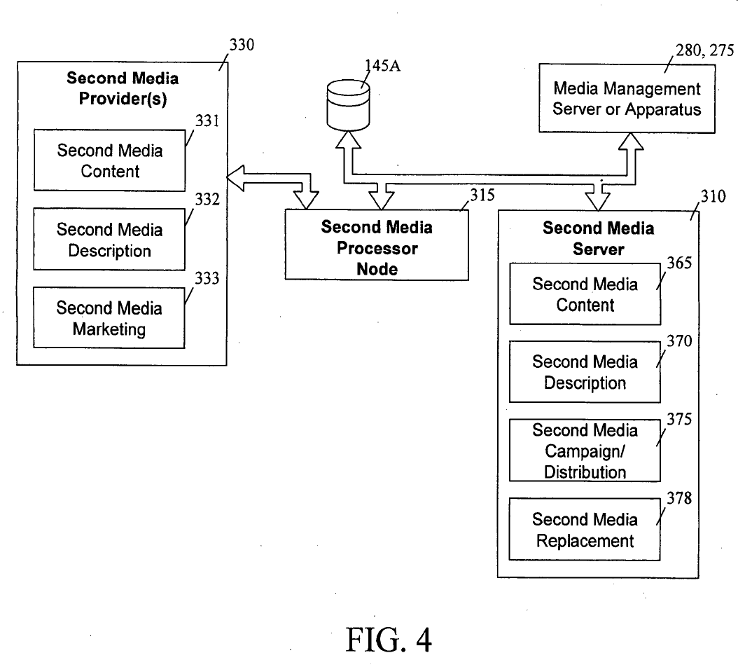

FIG. 4 is a block diagram illustrating in greater detail exemplary apparatus embodiments for a second media processor node 315 and a second media server 310 in accordance with the teachings of the present invention. The second media processor node 315 utilizes second media and other data (such as second media descriptions and marketing requirements) provided by a second media provider 330, generating a second media content module 365, a second media description module 370, and any second media marketing campaign or other requirements 375, and stores these modules on the second media server 310. As described in greater detail below, all these modules are stored and formatted using the media description language of the present invention.

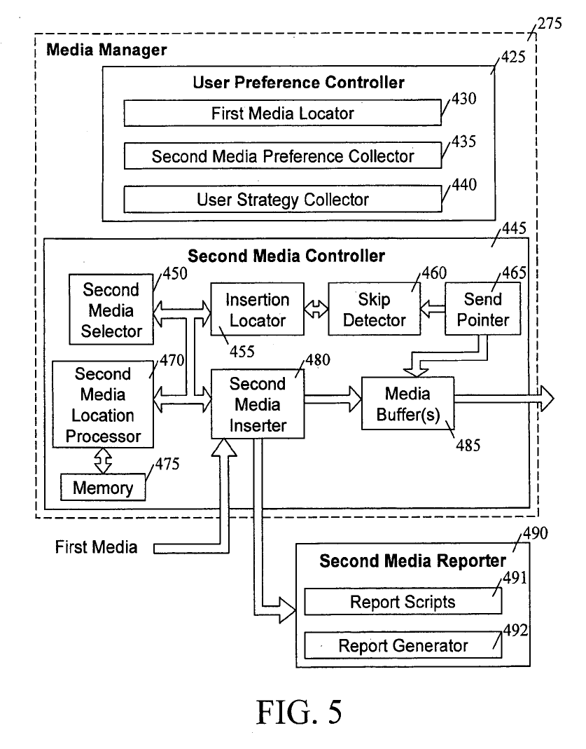

FIG. 5 is a block diagram illustrating in greater detail exemplary apparatus embodiments for a media management apparatus 275 and second media reporter 490 in accordance with the teachings of the present invention. As mentioned above, the media management apparatus 275 may be embodied within a media management server 280, or may be integrated with a media player 250. The media management apparatus 275 combines the various first and second media modules to produce the interleaved or combined primary and secondary media streams, providing a resulting, combined media stream for use by the consumer, such as for viewing.

When the media management apparatus 275 is embodied within a media management server 280, the viewer uses his or her own unmodified media player 240 and, for a video example, the resulting, combined media stream is distributed over the Internet for use by the media player 240, such as for viewing by the user. For distributing the combined media stream, the user preference controller 425 of the media management apparatus 275 reads the stored first and second media modules, and selects the primary media stream to play using the first media locator 430, selects second media that matches the viewer's profile using the second media preference collector 435 and second media selector 450 (of the second media controller 445). The second media is then placed or inserted within the primary media stream, in a location that generally matches the user's desired second media viewing strategy (collected by the user strategy collector 440), using the insertion locator 455 and second media inserter 480, forming the combined media stream, which is then stored (buffer 485)) as corresponding packets for distribution to the user (or provided directly as the combined media stream, when integrated with a media player 250).

To prevent the system 200 from being circumvented or used without authorization, the first and second media may be protected from modification or unauthorized viewing by scrambling or encrypting the data, such as before it is distributed to the second media controller 445, or elsewhere in the media stream, and may be implemented using any of the known means to protect data and information. For example, the various primary and secondary media streams may be sent over secure channels, or different channels, or separated steams. The means of doing this is unimportant to this invention, and is assumed to be implemented for illustration purposes by having the data protected by encryption.

The media description language captures relevant information in a common, universal extendable format. Three corresponding modules are defined respectively for each first media and each second media: (1) an archived first media content module 360 and a second media content module 365, which respectively contains the content of the first or second media that is expected to remain unchanged for some period of time; (2) a characteristics and requirements module 350 and a second media description module 370, which respectively store information relevant to selecting the first media and the second media that matches the user's preferences (this information may initially be changing on a dynamic basis, but as user statistics are collected, it may tend to become relatively stable; and (3) a first media content market module 355 and a second media campaign or distribution module 375, which save and store relevant financial and marketing data for matching and collecting revenue. These modules are expected to change throughout the life of the first and second media, as different marketing campaigns are run, etc.

In operation, the user first enters his or her second media preferences and second media viewing strategies into the second media preference collector 435 and user strategy collector 440. This should be done before the media is viewed and the information is collected in the same categories and format as specified in the media description language. The preferences and strategies can be updated at anytime thereafter. If the user does not enter second media preferences or a second media viewing strategy, the media management apparatus 275 may either require that they be completed before the viewing, or may select a default set, such as where the preferences may match the description of the first media being viewed, and the second media strategy may match the second media philosophy of the media provider. Next, the user finds the first media to be viewed using the first media locator 430, providing for a user to specify a particular first media content or allowing them to browse and search the available content using the data stored in the characteristics and requirements module 350 of each first media content on the first media servers 210.

Once the first media content is selected, the first media content locator 430 locates a first media server 210 having the requested first media, which may be local or remote. The second media controller 445 the determines corresponding second media for insertion or combining with the first media. More particularly, the second media location list processor 470 downloads or otherwise determines the logical second media locations in the first media, from the characteristics and requirements module 350. The second media selector 450 uses the user's second media preferences and determines corresponding, generally matching second media, such as by matching the data in the second media description module 370 with the user's preferences provided by the second media preference collector 435. The second media selector 450 also provides that the second media is compatible with the first media by comparing the second media description module 370 to the first media characteristics and requirements module 350.

The insertion locator 455 applies the user's second media insertion strategy (from the user strategy collector 440) and tentatively identifies where second media will be placed into the first media. This selection strategy includes the type of second media (e.g., displayed full screen, superimposed on the first media (e.g. watermarked), in a window of the first media, or streamed across the bottom or top of the screen) and the location (e.g., all second media at the beginning or end of the first media, or distributed throughout the first media), at some or all of the logical insertion points on the second media location list (from processor 470). In addition, any revenue requirements of the first media provider are compared to the revenues anticipated to be collected from the proposed second media insertions, and corresponding revisions are made if the anticipated revenue may be insufficient. The user also may be given the option for paying directly for the first media and avoiding viewing any second media, or even viewing extra second media such as ads or “micro-payment” ads, and building up “micro-payment” credit that can be used for future viewing of first media or redeemed for cash or products.

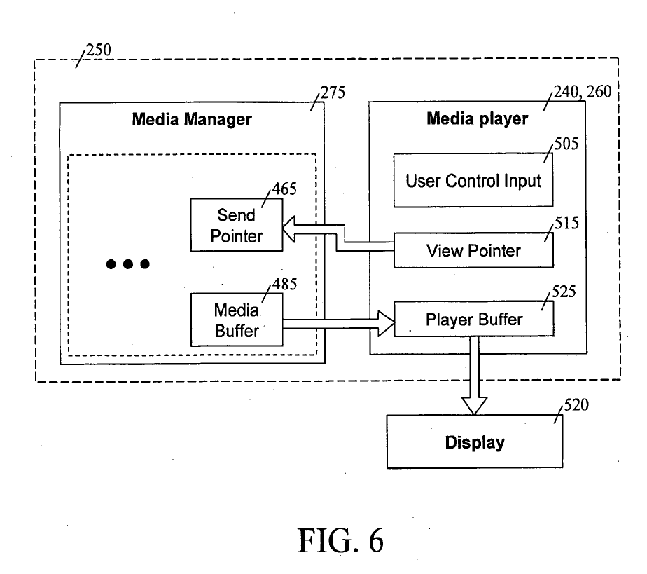

FIG. 6 is a block diagram illustrating in greater detail an exemplary media viewer or player apparatus 240, 250, 260 in accordance with the teachings of the present invention. Only portions of the media manager 275 are illustrated in FIG. 6 for purposes of showing connections with the media player 240, 250, 260, it being understood that the other components illustrated in FIG. 5 are also included in the media manager 275. Referring to FIGS. 5 and 6, for the situation of a legacy media player (240) which does not include an integrated media manager 275, the resulting set of second media is combined with first media by the media management server 280 to form the resulting, combined media stream transmitted to the user's media player 240. More particularly, the second media inserter 480 then combines the second media with the first media, which may be in the form of a primary media stream, at the specified locations. For example, the second media inserter 480 may include a switching mechanism (not separately illustrated), which is then directed to change sources, superimpose, or watermark the second media onto or into the primary media stream, forming the combined media stream transmitted to the media player 240.

For the situation of a media player (250) which does include an integrated media manager 275, the resulting set of second media may then form a secondary media stream, which may be provided directly to a media player 250 having an integrated media manager 275. The second media may be provided at any time, such as in advance of the first media, during transmission of the first media, or more generally, largely independently of and asynchronously with the first media. The first media is also provided to the media player 250, as the primary media stream. The second media is then combined with first media within the user's media player 250 to form the resulting, combined media stream played to or viewed by the user. More particularly, the second media inserter 480 then combines the second media (selected from the secondary media stream) with the primary media stream, such as by inserting the second media at the specified locations within the primary media stream, or superimposing or watermarking the second media onto or into the primary media stream, forming the combined media stream which is then utilized for viewing or playing (e.g., packets decoded and assembled by the other features of the media player 250).

To deliver this media stream to the viewer without skips or jumps, the primary and secondary media streams, or the combined media stream, are or is buffered both before and after transmission over the Internet, as shown in FIG. 5 with the media buffer 485 and in FIG. 6 as the player buffer 515. When the media player (250) does include an integrated media manager 275, the primary media stream and the secondary media stream may be buffered separately or combined together into one buffer. For the media player (250) which does include an integrated media manager 275, the media and player buffers 485, 525 may be combined into a singular set of buffers. Those having skill in the electronic arts will recognize that suitable or additional buffers (not separately illustrated) may be included to ensure that both first and second media are available when needed.

For a legacy media player (240) which does not include an integrated media manager 275, the media player 240 accepts an input IP data stream and displays it on the output display 520. The media player 240 may have a viewer control input 505 (or remote control) providing start, stop, pause, and forward/reverse operation. To implement these functions, the media player 240 has a view pointer 515 that points to the position in the media being played and changes it as requested by the viewer. If a viewer fast-forwards, the view pointer 515 is set ahead.v If the buffering is set low, which is a default mode the media manager 275 may setup, the player will have to jump the send pointer 465 ahead to send the new part of the combined media stream. (If the buffering is large, there is the possibility that the media player 240 can skip ahead over second media without viewing it and without setting the send pointer 465 ahead, which is why exemplary embodiments maintain the buffering as comparatively low as practicable.) The skip detector 460 (continuously or periodically) monitors if a second media location is being skipped over during these pointer jump aheads, and if so, it triggers the insertion locator 455 to insert the skipped second media as soon as normal play is resumed. If skipping backward (reversing), the skip detector 460 may also suppress any repeated viewing of second media (which has already been viewed) if that is a viewer preference (e.g., sets in their second media strategy (440).

For the media player (250) which does include an integrated media manager 275, most if not all uncertainties in detecting a user skipping ahead are eliminated, because the actual place being viewed is available to the skip detector 460, and because the view pointer 515 and send pointer 465 can be integrated into a single element. This gives the integrated media manager 275 full control and prevents the viewer from buffering a large part of the combined media stream (or recording the stream) and viewing it while skipping over the inserted second media.

The wireless media player 260 may be implemented to include (250) or to not include (240) an integrated media manager 275 and function accordingly as described above. Wireless components, such as antenna and wireless transceivers, are not illustrated in FIG. 6, and are readily known to those having skill in the electronic arts.

The second media reporter 490 monitors the second media inserter 480 and skip detector 460 to identify all the second media played and viewed by the user. The second media reporter 490 sends billing information for the inserted or otherwise combined second media and the revenue expected by the first media provider to a database (e.g., 145A) or other memory in the second media reporting server 320. In addition, the second media reporter 490 also sends the preference matching data for the first media, the second media, and user, so reports can be generated off-line by the report scripts 491 and report generator 492 associated with the second media reporting server 320. The reports show the effectiveness of the second media and first media so the media providers (e.g., advertiser, ad agency, and first media providers) know and can modify their campaigns and other strategies and to get a potentially optimal return. In addition, since the users may directly pay for viewing first media or collect the “mini-payments” for viewing second media, the viewers will also get reports documenting their viewing, charges, and credits.

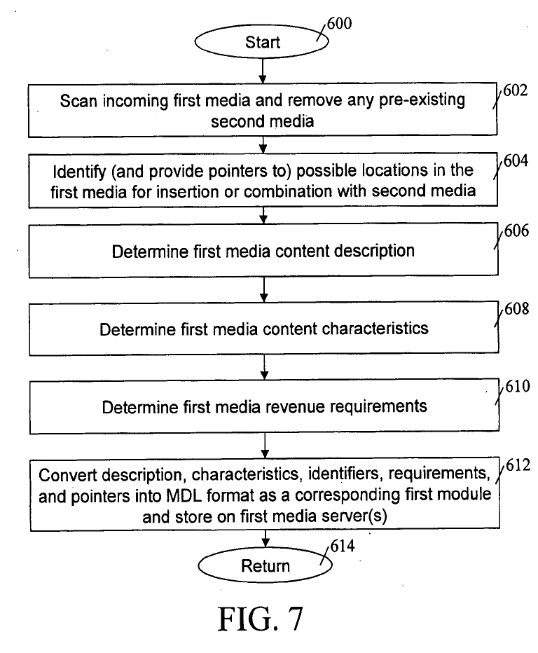

FIG. 7 is a flow diagram illustrating generation of a media description language description for first media in accordance with the teachings of the present invention. As mentioned above, the exemplary embodiments utilize a media description (and mark-up) language (“MDL”) for positioning of second media within the first media. Beginning with start step 600, the unmodified or “raw” incoming first media content is first scanned and any existing second media is removed, step 602. Next the first media content is pre-processed to identify (and provide pointers to) many (if not all) possible locations in the first media for insertion or combination with second media, step 604. Existing location markers may be used if present, and new locations are identified from scene changes, breaks in the program, audio changes, etc. The identified locations are determined and entered in the (second media) location list in an MDL format for the first media content.

A first media content description, including first media provider and identification, is collected for entering into the MDL header, step 606. The first media content characteristics are collected from the first media provider or its representative for entering into the MDL format, step 608. The first media revenue requirements are collected from the first media provider for entering into the MDL format, step 610. The MDL information which includes potential second media locations is then collected, and may optionally include the processed first media, converted or formatted into an MDL format as a first module, step 612 and stored on the first media servers in an MDL format, and the method may end, return step 614. For example, in an exemplary embodiment, an MDL format for first media may comprise (where “xx's” refer to corresponding information) the following:

```
Header
  ID, xxxx
Description
  xxxx
Characteristics
  xxxx
Revenue
  xxxx
Location Pointers
  xxxx xxxx xxxx
Content
  xxxxxxxxxxxxxxxxxxxxxxxxxxxxx
```

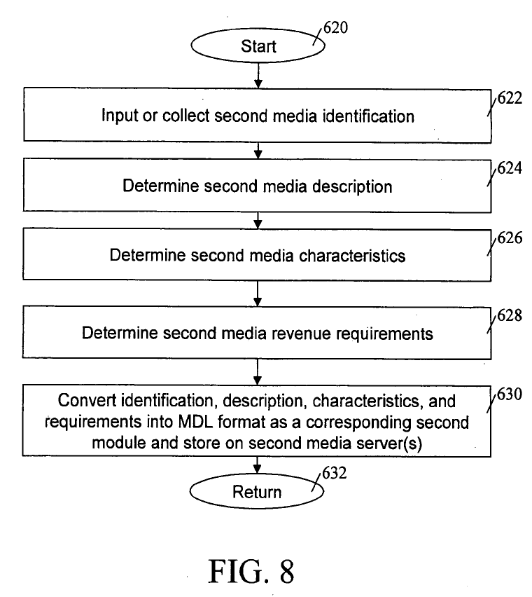

FIG. 8 is a flow diagram illustrating generation of a media description language description for second media in accordance with the teachings of the present invention, such as for advertisements, endorsements, etc. In exemplary embodiments, the media description includes the second media owner, the second media development agency (such as an ad agency) and other second media identification. Beginning with start step 620, this information is input or otherwise collected for entering into the second media MDL header, step 622. The second media content description and characteristics that are used for preference matching are collected from the second media provider for entering into the MDL format, steps 624 and 626. The second media revenue producing requirements are collected from the second media provider for entering into the MDL format, step 628. All the MDL information for the second media is collected, optionally together with the second media (such as an ad clip), formatted into an MDL format as a corresponding second module, and stored on the second media servers in the MDL format, step 630, which may also include alternative second media content, and the method may end, return step 632. For example, in an exemplary embodiment, an MDL format for second media may comprise (also in which “xx's” refer to corresponding information) the following:

```
Header
  ID, xxxx
Description
  xxxx
Characteristics
  xxxx
Revenue
  xxxx
Content
  xxxxxxxxxxxxxxxxxxxxxxxxxxxxx
Alternative Content
  xxxxxxxxxxxxxxxxxxxxxxxxxxxxx
```

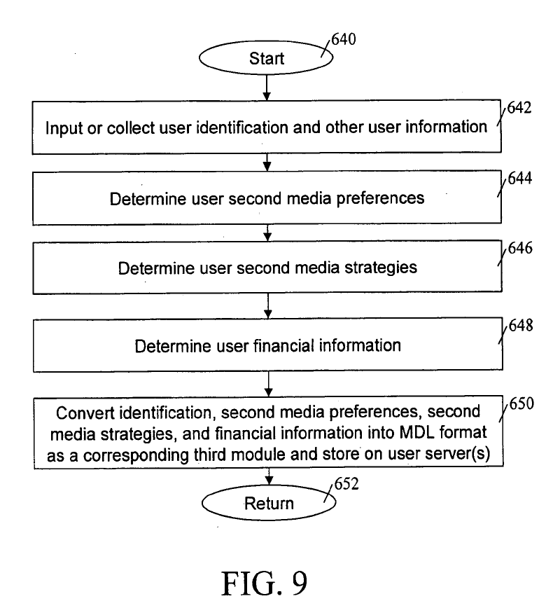

FIG. 9 is a flow diagram illustrating generation of a media description language description for input of user data through a media player apparatus in accordance with the teachings of the present invention. Because first media, second media and user strategies and preferences are formatted in generally the same structure, matching in the media manager 275 and generating reports is comparatively easier. Generally speaking, the flow diagram of FIG. 9 is a comparatively idealistic view of the process for capturing and storing user information, as generally this process will be more fluid than generating the MDL information for the first and second media. Beginning with start step 640, the user initially signs-up for service and enters various user information, such as identification information. This information may change over time, and may be re-entered (such as through a drop down menu) or through other means of communication with the media provider or other service provider, such as in writing, via fax, via telephone, etc. In all cases, the data changes are recorded in the viewer server databases (e.g., 145) which also keep track of the change history.

The user's preferences for first media and second media, as well as the desired strategy for how the second media will be placed into the first media, may also be entered or otherwise determined, steps 644 and 646, and are also expected to change over time and with use of the system 200. When the viewer selects first media, such as a particular video for viewing, they are likely to specify different content preferences, different second media preferences, different desires for payment types, and different strategies for placement of the second media into the first media, which are entered in steps 644 and 646. For example, when the second media is a form of advertisement, the user may specify subjects, such as automobiles, cosmetics, baby apparel, etc., and may specify their preferences for combining with the first media, such as at the beginning, middle or end of the first media, interspersed throughout the first media, or redirected to another device, for example. User financial and payment data may also be determined step 648, such as preferred billing or payment information, or whether second media consumption credits will be used for viewing additional first media or for receiving a financial payment. These types of data concerning user identification, second media preferences, second media strategies, and financial information are collected, converted and formatted into an MDL format, such as by the user preference controller 425 or any other processing node or media manager 275, and stored as a corresponding third module in one of the databases 145, step 650, and the method may end, return step 652. For example, in an exemplary embodiment, an MDL format for user preferences and strategy may comprise (also in which “xx's” refer to corresponding information) the following:

```
Header
  ID, xxxx
First media preferences
  xxxx
Second media content preferences
  xxxx
Second media strategy preferences
  xxxx
Payment preferences
  xxxx
Payment credits
  xxxxxxxxxxxxxxxxxxxxxxxxxxxxx
```

While all the exemplary implementations illustrated above use a media manager 275 and player system that matches the user's second media preferences and strategies with first media requirements, the media description language can be used with any system even those that do not utilize all features and capabilities of the language. The benefit is that the modules created can be used with other systems and future versions of the initially limited system. The extensibility of the language enables it to grow to include features not included in this current description.

The extensible media description language captures relevant information in a common, generally universal and extendable format. Three or more modules or files are defined for each first media:

(1) an archived content module 360, which contains the content of the first media after it has been stripped of any legacy or other second media by the second media locator/remover 335. This module is generally expected to remain unchanged over the life of the media.

(2) a characteristics and requirements module 350, which stores information for selection of the corresponding first media, typically as provided by the first media providers, through the provider terms manager 345. In addition, it stores the second media location insertion points as identified by the second media location analyzer 340. This information may initially be volatile or changing, but as the media providers collect statistics from the viewers, it may tend to become comparatively stable.

(3) a content market module 355, which stores financial and marketing data for matching and collecting revenue, as provided by the content providers through the provider terms manager 345. This information may be expected to change throughout the life of the first media as different marketing campaigns are run, etc.

Three or more modules or files are also defined for each second media:

(1) a second media content module 365, which contains the provided second media content 331 that is packaged by the second media processor node 315 and stored on the second media server 310. This module is generally expected to remain unchanged over the life of the second media.

(2) a second media description module 370, which stores information for selecting the second media, as provided by the second media provider, such as an advertiser or advertising agency 32, such as in the second media description 332 and second media marketing 333, as processed by the second media processor node 315. This information may initially be volatile, but as second media providers collect statistics from the media application, it will tend to become stable.

(3) a second media campaign module 375, which stores financial and marketing data for matching and collecting revenue from the second media provider, as provided by the second media provider, such as an advertiser or advertising agency 32, such as in the second media description 332 and second media marketing 333, as processed by the second media processor node 315. This module is expected to change throughout the life of the second media as different marketing campaigns are run, etc.

In an exemplary embodiment, a fourth module is also utilized:

(4) a second media replacement module 378 which stores information about where in the first media a new second media should be placed, and any actions or behaviors in the first or second media when the user encounters the second media, such as fast-forwarding or interactive engagement. For example, the media manager 275 may determine that certain second media is being skipped over frequently, so may replace that second media with replacement second media which may be more attractive or relevant to users.

As an example and without limitation, the following are some parameters that may be stored in the modules, and is by no means exhaustive. Indeed, it is anticipated that the list is extensible and will continually grow as new or updated parameters are introduced to capture characteristics and preferences:

Interest Profile
first media content type (sports, documentary, sci-fi, . . . )
second media type (autos, pharmaceuticals, housing, do-it-yourself, . . . )
first media content category
second media category
first media content sub-category
second media sub-category
second media actors
first media content actors

Demographics
first media provider's user demographics
second media provider's user demographics

Marketing and Revenue Collection
second media revenue paid per viewing
second media maximum cost not to be exceeded
first media content revenue required per viewing
   For each characteristic, fields may be provided to store a weighting to apply to matching, whether a complete match or a predetermined degree of matching is required, and if use is denied for certain user, advertiser or content characteristics. Also as mentioned above, the data in the modules may be encrypted or protected so only authorized users and authorized application programs can read, write or modify the data. When unencrypted, the format of the data can be any standard format; however, it is suggested that the description, preference, and marketing data be in a simple structured ASCII format to allow ease of use by different users on different platforms.

The following are examples of a possible implementation of the media description language expressed as a markup language. It will capture relevant information and make it available from servers, so that searching and matching can be performed for first media content location and second media selection and insertion. Another implementation of the Media Description Language is to express it as a particular set of instances of a structured database 145, where the database 145 is structured to capture these same sets of information. The database 145 implementation has the advantage of providing very efficient searching and matching, which may otherwise be performed by another processing node or a media manager 275, for example. Any and all such implementations are considered to be within the scope of this invention.

### Example 1

### A Media Mark Up Language Implementation for First

### Media

Master Header Section File

<UID>
A unique identifier number assigned to each first media
stream, which can also be used as key into an internal
database where the header is stored in an unparsed table.
A 256 bit binary number, large enough to not outgrow a
reasonable number space
<Start of Section Marker>
<CRC>
A CRC calculation we can use to confirm that the contents
of this section are not corrupted; a 32 bit binary value.
<Master Header Section>
<Version Number>
Version number of this header
1.n.m where first digit before a dot is generation,
digits after first dot are releases
Can be of forms
1
1.n
1.n.m
<Count of sections including this master header that
follow>
N where n is a 16 bit integer value, such that larger
values could potentially be more difficult to parse.
<List of section names, file names, and storage locations>
List of all sections in the format of a null terminated
section name, null terminated file name, and double null
terminated storage location.

First Media Content Owner Section File

```
<UID>
<Start of Section Marker>
<CRC>
A CRC calculation we can use to confirm that the contents
of this section are not corrupted; a 32 bit binary value.
<Media Content Owner Section>
  < Name of Owner>
  A null terminated string of characters
  <Web address for owner>
  A null terminated string of characters
  <Email address for contacting owner>
  A null terminated string of characters
  <New Key Definition><Key><End Key>
  Data for this new entry
  <End Data><Key><End Data Key>
  <Private entries>
  Expanded as required
  <END of Section Marker>
```

First Media Information Section File

```
<UID>
<Start of Section Marker>
<CRC>
A CRC calculation we can use to confirm that the contents
of this section are not corrupted; a 32 bit binary value.
<Media Info Section> <Optional can be NULL>
    <First Media artists list>
    A list of null terminated strings of artists who
created the content
    List terminated by double nulls
    <Date created>
    Date in a string format day.month.year
    <Brief description of the first media>
    A string with < 200 characters describing the
content
    <ART JPEG image>
    A location as web address of where to get a JPEG
image of ART for the content
    Examples are cover art, Photos of the artists
etc.
  <New Key Definition><Key><End Key>
  Data for this new entry
  <End Data><Key><End Data Key>
    <END of Section Marker>
```

Second Media Location Section File

```
<UID>
<Start of Section Marker>
<CRC>
A CRC calculation we can use to confirm that the contents
of this section are not corrupted; a 32 bit binary value.
<Second Media Location Section>
  <Second Media count total>
  A 16 bit integer value for total number of second
media locations
  <Stream type>
  A 16 bit integer value for stream type identification
  Examples 1=MPEG 2=MPEG2 3=MPEG4 4=JPEG 5=JPEG2 etc.
  <Second media locations in stream>
  A list of double null terminated 32 bit integers that
  indicate positions in the stream that follow
    <Second Media types possible>
  A list of strings null separated that describe the
  types of possible ads that can be embedded
    second media types: audio, video, picture, text
etc.
  <New Key Definition><Key><End Key>
  Data for this new entry
  <End Data><Key><End Data Key>
    <END of Section marker>
```

Second Media Selection Information Section File

```
<UID>
<Start of Section marker>
<CRC>
A CRC calculation we can use to confirm that the contents
of this section are not corrupted; a 32 bit binary value.
<Second Media Selection Info Section>
  <Preferred Second Media locations global>
  A linked list of locations each value a 16 bit
  integer, list terminated by double nulls
    <Preferred Second Media locations by user type>
  A linked list of locations each value a 16 bit
  integer, list terminated by double nulls
  <Second Media locations with highest value>
  A linked list of locations each value a 16 bit
  integer, list terminated by double nulls
  <Private data> expanded as required
  A linked list of locations each value a 16 bit
  integer, list terminated by double nulls
  <Average time Second Media skipped in content>
  A linked list of locations each value a 16 bit
  integer, list terminated by double nulls
  <Second Media types least frequently skipped>
  A linked list of locations each value a 16 bit
  integer, list terminated by double nulls
  < Table values for Second Media matching>
    per the database set up
  <New Key Definition><Key><End Key>
  Data for this new entry
  <End Data><Key><End Data Key>
<END of Section Marker>
```

Content Revenue Requirements Section File

```
<UID>
<Start of Section Marker>
<CRC>
A CRC calculation we can use to confirm that the contents
of this section are not corrupted; a 32 bit binary value.
<Content Revenue Requirements Section>
  < Payee>
  A null terminated string of characters
  <Web address for Payee>
  A null terminated string of characters
  <Email address for contacting payee>
  A null terminated string of characters
  < Link to pricing policy>
  A Null terminated string of characters
  < Preferred minimum price in cents>
  An 8 bit integer value
  <Average price per second media>
  A linked list of locations each value a 16 bit
  integer, list terminated by double nulls
  <Premium price per second media>
  A linked list of locations each value a 16 bit
  integer, list terminated by double nulls
  <New Key Definition><Key><End Key>
  Data for this new entry
  <End Data><Key><End Data Key>
  <Private entries>
  Expanded as required
  <END of Section Marker>
```

First Media Content Section File

```
<UID>
<Start of Section Marker>
<CRC>
A CRC calculation we can use to confirm that the contents
of this section are not corrupted; a 32 bit binary value.
<Content Section>
  < Content Type>
  An 8 bit integer value representing MPEG4, H/264, ... . .
  < Content>
Content formatted in the native content type format
<END of Section Marker>
```

### Example 2

### A Media Mark Up Language Implementation for

### Second Media

Master Header Section File

<UID>
A unique identifier number assigned to each media stream,
can also be used as key into an internal database where the
header is stored in an unparsed table.
A 256 bit binary number, large enough to not outgrow a
reasonable number space
<Start of Section Marker>
<CRC>
A CRC calculation we can use to confirm that the contents
of this section are not corrupted; a 32 bit binary value.
<Master Header Section>
<Version Number>
Version number of this header
1.n.m where first digit before a dot is generation,
digits after first dot are releases
Can be of forms
1
1.n
1.n.m
<Count of sections including this master header that
follow>
N where n is a 16 bit integer value, such that larger
values could potentially be more difficult to parse.
<List of section names, file names, and storage locations>
List of all sections in the format of a null terminated
section name, null terminated file name, and double null
terminated storage location.

Second Media Owner Section File

```
<UID>
<Start of Section Marker>
<CRC>
A CRC calculation we can use to confirm that the contents
of this section are not corrupted; a 32 bit binary value.
< Second Media Owner Section>
  < Name of Owner>
  A null terminated string of characters
  <Web address for owner>
  A null terminated string of characters
  <Email address for contacting owner>
  A null terminated string of characters
  < Link to pricing policy>
  A Null terminated string of characters
  <Private entries>
  Expanded as required
  <New Key Definition><Key><End Key>
  Data for this new entry
  <End Data><Key><End Data Key>
  <END of Section Marker>
```

Second Media Info Section File

```
<UID>
<Start of Section Marker>
<CRC>
A CRC calculation we can use to confirm that the contents
of this section are not corrupted; a 32 bit binary value.
< Second Media Info Section> <Optional can be NULL>
    < Second Media artists list>
    A list of null terminated strings of artists who
created the content
    List terminated by double nulls
    <Date created>
    Date in a string format day.month.year
    <Brief description of the media>
    A string with < 200 characters describing the
content
  <New Key Definition><Key><End Key>
  Data for this new entry
  <End Data><Key><End Data Key>
<END of Section Marker>
```

Second Media Selection Info Section File

```
<UID>
<Start of Section marker>
<CRC>
A CRC calculation we can use to confirm that the contents
of this section are not corrupted; a 32 bit binary value.
< Second Media Selection Info Section>
  <Preferred Second Media locations global>
  A linked list of locations each value a 16 bit
  integer, list terminated by double nulls
    <Preferred Second Media locations by user type>
  A linked list of locations each value a 16 bit
  integer, list terminated by double nulls
  <Second Media locations with highest value>
  A linked list of locations each value a 16 bit
  integer, list terminated by double nulls
  < Table values for Second Media matching>
  TBD
  <New Key Definition><Key><End Key>
  Data for this new entry
  <End Data><Key><End Data Key>
  <END of Section Marker>
```

Second Media Revenue Generated Section File

```
<UID>
<Start of Section Marker>
<CRC>
A CRC calculation we can use to confirm that the contents
of this section are not corrupted; a 32 bit binary value.
<Second Media Revenue Generated Section>
  < Payer>
  A null terminated string of characters
  <Web address for Payer>
  A null terminated string of characters
  <Email address for contacting payee>
  A null terminated string of characters
  < Link to pricing policy>
  A Null terminated string of characters
  < Price per Second Media vs. location for primary
Second Media >
  A linked list of locations each value a 16 bit
  integer, followed by 8 bit integer max. price in cents
  list terminated by double nulls
  < Price per Second Media vs. location for alternate 1
Second Media >
  A linked list of locations each value a 16 bit
  integer, followed by 8 bit integer max. price in cents
  list terminated by double nulls
  <New Key Definition><Key><End Key>
  Data for this new entry
  <End Data><Key><End Data Key>
  <Private entries>
  Expanded as required
  <END of Section Marker>
```

Second Media Section File

```
<UID>
<Start of Section Marker>
<CRC>
A CRC calculation we can use to confirm that the contents
of this section are not corrupted; a 32 bit binary value.
< Second Media Section >
  < Second Media Type>
  A 8 bit integer value representing MPEG4, H/264,... .
  < Second Media >
  Second Media formatted in the native type format
  <END of Section Marker>
```

Alternate 1 Second Media Section File

```
<UID>
<Start of Section Marker>
<CRC>
A CRC calculation we can use to confirm that the contents
of this section are not corrupted; a 32 bit binary value.
< Alternate 1 Second Media Section >
  < Second Media Type>
  A 8 bit integer value representing MPEG4, H/264, ... .
  < Second Media >
  Second Media formatted in the native type format
  <END of Section Marker>
```

### Example 3

### A Media Mark Up Language Implementation for User

### Data

Master Header Section File

<UID>
A unique identifier number assigned to each media stream
can also be used as key into an internal database where the
header is stored in an unparsed table.
A 256 bit binary number, large enough to not outgrow a
reasonable number space
<Start of Section Marker>
<CRC>
A CRC calculation we can use to confirm that the contents
of this section are not corrupted; a 32 bit binary value.
<Master Header Section>
<Version Number>
Version number of this header
1.n.m where first digit before a dot is generation,
digits after first dot are releases
Can be of forms
1
1.n
1.n.m
<Count of sections including this master header that
follow>
N where n is a 16 bit integer value, such that larger
values could potentially be more difficult to parse.
<List of section names, file names, and storage locations>
List of all sections in the format of a null terminated
section name; null terminated file name, and double null
terminated storage location.

User Identification Section File

```
<UID>
<Start of Section Marker>
<CRC>
A CRC calculation we can use to confirm that the contents
of this section are not corrupted; a 32 bit binary value.
< User Identification Section >
  < Name of User >
  A null terminated string of characters
  <Web address for owner>
  A null terminated string of characters
  <Email address for contacting owner>
  A null terminated string of characters
  <Viewer Demographics>
  Standard list of demographic info inserted here
  <Viewer Interests>
  Standard list of interests and hobbies inserted here
  <Private entries>
  Expanded as required
  <New Key Definition><Key><End Key>
  Data for this new entry
  <End Data><Key><End Data Key>
  <END of Section Marker>
```

First Media Content Preference Section File

```
<UID>
<Start of Section Marker>
<CRC>
A CRC calculation we can use to confirm that the contents
of this section are not corrupted; a 32 bit binary value.
< First Media Content Preference Section > <Optional can
be NULL>
  < First Media Content category preference 1>
  16 bit integer representing content category
  < First Media Content type preference 1>
  16 bit integer representing content type
  < First Media Content Duration preference 1>
  16 bit integer number of seconds duration
  < First Media Content category preference 2>
  16 bit integer representing content category
  < First Media Content type preference 2>
  16 bit integer representing content type
  < First Media Content Duration preference 2>
  16 bit integer number of seconds duration
  < First Media Content category preference 3>
  16 bit integer representing content category
  < First Media Content type preference 3>
  16 bit integer representing content type
  < First Media Content Duration preference 3>
  16 bit integer number of seconds duration
  < First Media Content artists list>
  A list of null terminated strings of artists who
  created the First Media content
    List terminated by double nulls
  <New Key Definition><Key><End Key>
  Data for this new entry
  <End Data><Key><End Data Key>
<END of Section Marker>
```

Second Media Preference Section File

```
<UID>
<Start of Section Marker>
<CRC>
A CRC calculation we can use to confirm that the contents
of this section are not corrupted; a 32 bit binary value.
< Second Media Preference Section> <Optional can be NULL>
  < Second Media product category preference 1>
  16 bit integer representing Second Media product
  category
  < Second Media type preference 2>
  16 bit integer representing infomercial, standard TV-
  like commercial, interactive commercial, banner ad,
  inserted window overlay, watermarked ad, etc.
  <Second Media Duration preference 1>
  16 bit integer number of seconds duration
  < Second Media product category preference 2>
  16 bit integer representing Second Media product
  category
  < Second Media type preference 2>
  16 bit integer representing infomercial, standard TV-
  like commercial, interactive commercial, banner ad,
  inserted window overlay, watermarked ad, etc.
  <Second Media Duration preference 2>
  16 bit integer number of seconds duration
  < Second Media product category preference 3>
  16 bit integer representing Second Media product
  category
  < Second Media type preference 3>
  16 bit integer representing infomercial, standard TV-
  like commercial, interactive commercial, banner ad,
  inserted window overlay, watermarked ad, etc.
  <Second Media Duration preference 3>
  16 bit integer number of seconds duration
  < Second Media artists list>
  A list of null terminated strings of artists who
  created the First Media content
    List terminated by double nulls
  <New Key Definition><Key><End Key>
  Data for this new entry
  <End Data><Key><End Data Key>
<END of Section Marker>
```

Second Media Placement Strategy Section File

```
<UID>
<Start of Section marker>
<CRC>
A CRC calculation we can use to confirm that the contents
of this section are not corrupted; a 32 bit binary value.
< Second Media Placement Strategy Section >
  <Percent of Second Media In Advance of First Media >
  16 bit integer percentage
  <Percent of Second Media equally distributed
throughout First Media >
  16 bit integer percentage
  < Second Media distributed at approximate intervals of
x seconds>
  16 bit integer number of seconds
  <New Key Definition><Key><End Key>
  Data for this new entry
  <End Data><Key><End Data Key>
  <END of Section Marker>
```

Viewer Payment Section File

```
<UID>
<Start of Section Marker>
<CRC>
A CRC calculation we can use to confirm that the contents
of this section are not corrupted; a 32 bit binary value.
< Viewer Payment Section >
  < Payee/Payer>
  A null terminated string of characters
  <Web address for Payee/Payer >
  A null terminated string of characters
  <Email address for contacting Payee/Payer >
  A null terminated string of characters
  <Viewer Payment multiplier >
  The percentage cost (in %) of Second Media free
  viewing the viewer is willing to pay (if negative, the
  viewer receives credit); a signed 16 bit integer
  If the First Media is free without Second Media, then
  no payments are taken from viewer and negative entries
  represent the number of cents the viewer expects to
  receive for viewing with ads.
  <New Key Definition><Key><End Key>
  Data for this new entry
  <End Data><Key><End Data Key>
  <Private entries>
  Expanded as required
  <END of Section Marker>
```

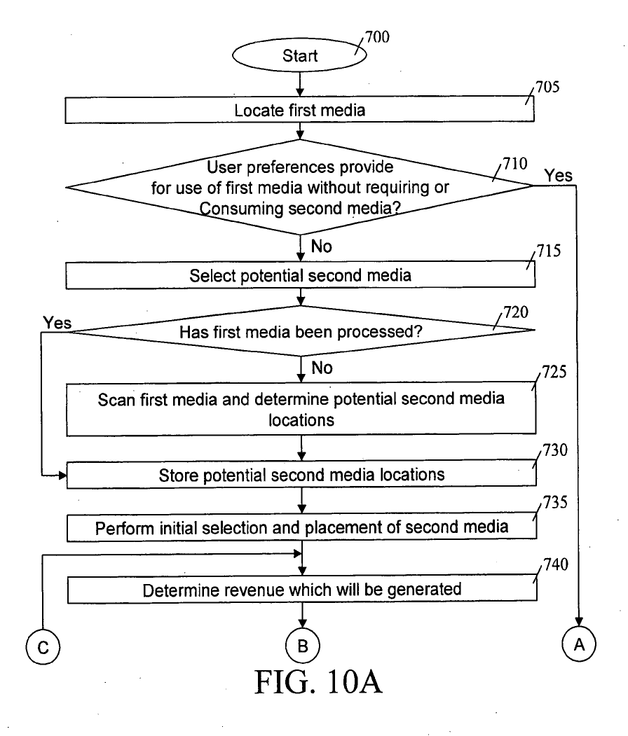

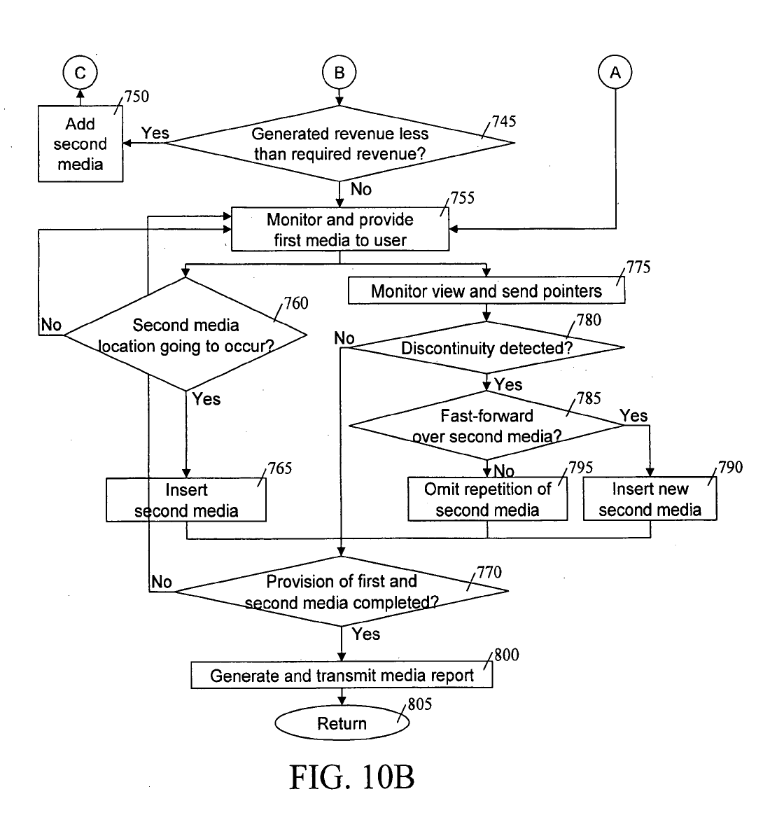

FIG. 10 is a flow diagram illustrating exemplary operation of a media player apparatus 240, 250, 260 and media manager 275 in accordance with the teachings of the present invention. The media player 250 includes the media manager 275 described above. For other media players, such as medial player 240, the media manager 275 operations described below occur within the media management server 280. During an initial start up, the media manager 275 of the media player 250 will have populated the user server(s) 255 with the user information described above, such as user identification, preferences for first media and second media, and viewing strategies, which may include a start up mode with various guided menus for the user to enter information. Similarly, the various processor nodes will have populated the first media servers 210 and the second media servers 310 with the identification ID, identification information, revenue requirements, location pointers, first media, second media, and other information as discussed above.

Beginning with start step 700, the first media locator 430 locates the first media that the user has selected, step 705, such as (1) by finding the particular first media that matches the user's specific content request, by searching the header information on the first media servers 210; or (2) by suggesting similar content of first media which is available on first media servers 210, based on first media content characteristics that may closely match the user's content preferences (provided by the user and stored on the user server 255); or (3) allowing the user to interactively select a specific first media (such as from a listing of available first media) or to request another set of suggestions. Also stored on the user server 255 are the user's payment preferences, such as whether the user prefers to pay for the first media directly, or prefers to partially or fully subsidize the use (such as viewing) of the first media by viewing included or embedded second media, or prefers to build up credits or micropayments, such as by viewing additional second media.

The second media preference collector 435 then determines whether the user has elected to pay for first media without any inserted second media, step 710, and if so, the second media selecting and locating processes (steps 715-750 760, 765, 775-795) are skipped, and the first media may be used directly, proceeding to step 755, continuing without interruption, subject to user interactions (such as rewinding, fast-forwarding, etc.). Otherwise, the method proceeds to step 715.

After the first media has been located, and when the user has elected to receive second media, the second media selector 450 performs a three-way comparison and selects potential second media, step 715. More particularly, the second media selector 450 selects second media that are compatible with the content of the first media (by comparing the characteristics of the second media (from the second media server 310 and the characteristics of the first media (from the first media server 210), and then further compares and generally matches this with the second media characteristic preferences of the user (from the user server 255). Generally in parallel with this, when the first media selected by the user that has been pre-processed, step 720, the second media location list processor 470 stores locally the potential second media locations of the first media, step 730, such as in memory 475. When the first media selected by the user that has not been pre-processed, step 720, a default set of characteristics is provided for the first media and the second media location list processor 470 performs the additional function of scanning the first media and generating a list of second media locations, step 725, which may include use of placement heuristics such as scene changes, audio level shifts, other perceptible break points, etc.

The insertion locator 455 performs an initial placement of potential second media at selected locations (from the stored location list in memory 475), step 735, that generally match the user's second media placement strategy (provided by the user server 255). In an exemplary embodiment, such an initial placement will generally select and place an amount of second media to generate slightly less than the revenue required for the first media, to avoid an excess of second media. Other selection and placement schema may also be utilized equivalently, and are within the scope of the present invention. For example, if an initial placement were to generate more than the revenue required for the first media, then corresponding evaluation steps (similar to those described below) will be utilized to avoid requiring a significant excess of second media.

The insertion locator 455 then determines, step 740, the revenue that would be generated by the sum of the corresponding revenues of the selected second media (as stored in the second media server 310) and an amount the user is willing to pay directly (to reduce or eliminate any or some of the otherwise required second media, also information which has been stored in and obtained from the user server 255), and then compares and determines whether this initial generated revenue amount is sufficient, step 745, compared to the revenue requirements of the first media provider (based on the information stored in and obtained from the first media server 210) plus any additional credit the user may want for viewing additional second media (also obtained from the user server 255). If the generated revenue amount is insufficient in step 745, the insertion locator 455 adds more second media, step 750, and returns to step 740, and iteratively repeating steps 740, 745 and 750, until the generated revenue amount is sufficient.

It should be noted that if an initial placement were to generate more than the revenue required for the first media, then the method may include other steps, not separately illustrated, such as the insertion locator 455 then further determining whether the generated revenue amount is in excess, and if so, subtracting second media, and again iteratively repeats steps 740 and 745. Such methodology would also then include steps to select an amount and placement of second media which is just sufficient, to avoid repeated iterations of (and oscillation between) addition and subtraction steps.

It also should be noted that during these matching and evaluation processes, one or more of the selected second media may be played by the media player apparatus 240, 250, 260. For example, the second media having the highest generated revenue amounts can be played to the user during this process.

The second media inserter 480 then begins monitoring and providing the first media to the user, such as by streaming it to the user's media player 240, 260 (or to the media playing portion of a media player 250 with an integrated media manager 275) through the media buffer(s) 485, step 755. The second media inserter 480 monitors the current location of first media being provided, and determines when a second media location is or will be occurring. When a second media location is going to occur, step 760, the second media inserter 480 inserts the second media location at the appropriate second media location, step 765. For example, the second media inserter 480 may include a switch to insert second media at the identified locations, with the switch otherwise set to provide the first media. This can be a hard switching between first and second media streams, or an overlay of the second media stream onto the first media stream as a banner, watermark, or an inserted window. This can also be a switching in of the second media into the appropriate locations of the media buffer(s) 485. Following insertion of the second media, when the provision of the first and second media is not yet completed, step 770, the buffered first media in the media buffer(s) 485 is again provided, returning to step 755, and iteratively repeating steps 755, 760, 765, and 770. The buffering of the first and second media in the media buffer(s) 485 allows smooth, uninterrupted media usage, which can be played or otherwise used by the user through the media player 240, 250, 260.

During the provision of the first and second media, or following step 765, the user's media player 240, 260 (or to the media playing portion of a media player 250) engages in a “handshaking” process with the integrated media manager 275, through the view and send pointers 515, 465, respectively, to keep the media buffer(s) 485 current with the viewing or media use location, ensuring the next first media or next second media frames are available for viewing, step 775. The skip detector 460 monitors the view and send pointer locations, to keep the media buffers current with the view or use location, and to detect discontinuities (or jumps) when the user fast-forwards (or reverses) playback, step 780. If the viewer fast-forwards over a second media location that was identified for second media insertion, step 785, the skip detector 460 signals the second media inserter 480 to insert replacement second media. The second media inserter 480 then inserts second media with the same or similar revenue generation potential as the skipped second media, step 790. A default location may be used for insertion of the new second media, such as placing the second media at the point at which the viewer has stopped fast forwarding, or may be placed at another location when specified in the user's strategy for second media. If the discontinuity was not a fast-forward in step 785, indicating that the discontinuity was a reversal, the skip detector 460 signals the second media inserter 480 to avoid inserting additional or repetitive second media, step 795. The method determines whether the provision of the first and second media is completed, step 770, and when more first and second media are to be provided, the method returns to steps 755 and 775 for ongoing provision and monitoring of the first media and the second media.

During this time period, or upon completion of the provision of the first and second media as illustrated, the second media reporter 490 has been monitoring the events of the start and the end of the first media stream, plus the insertion and any skipping of second media. At each of these events, it sends the IDs of the user, the first media, the second media inserted (or skipped), the date and time, and any user comments or feedback, step 800. When the media manager 275 functions are integrated into the media player 250, there is a direct path through the media player for the user to input comments and feedback. The second media reporter 490 also checks and updates as necessary the user's second media preferences, second media strategy, and revenue (or payment) options on the user server 255. Following step 800, or otherwise when the provision of the first and second media is completed, the method may end, return step 805.

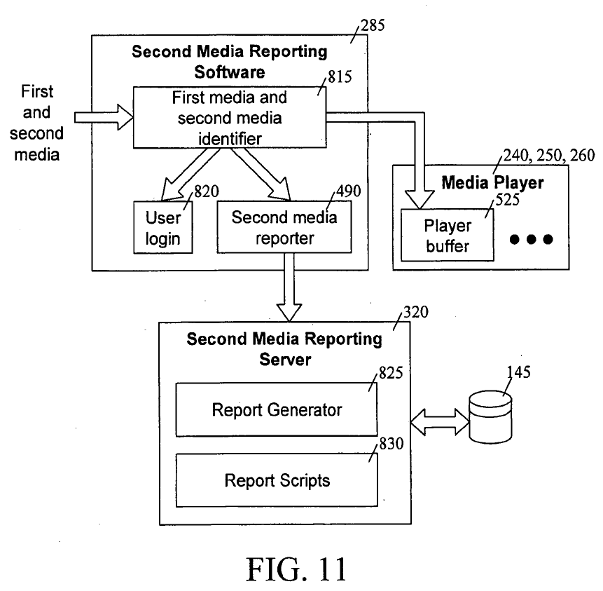

FIG. 11 is a block diagram illustrating a second media reporting system in accordance with the teachings of the present invention, illustrating in greater detail the interaction between the media player 240, 250, 260, the second media reporting server 310, and a second media reporting software 285, also referred to as “plug-in”, for use with a legacy media player 240, with a web-based portal, or which may be included with the media player 250 having the integrated media manager 275. For example, when the media player 240, 250, 260 is a software program on the user's computer or set-top box, the second media reporting software 285 may be downloaded and activated separately or as part of a media stream to the user's device. The second media reporting software 285 may be alternatively and equivalently embodied in hardware. The second media reporting software 285 passes the first and media unchanged directly through to the user's media player 240, 250, 260, into the player buffer (with the other components of the media player 240, 250, 260 not separately illustrated in FIG. 11). Within the second media reporting software 285, the first and second media identifier 815 monitors the media stream or streams as they passes through and identifies the first media and each second media (as there may be and are likely to be a plurality of second media) as each is being viewed. The identification may be done by any one or more of the following techniques:

(1) reading an identification tag inserted in the first media or the second media by the corresponding providers;

(2) reading a visible or invisible watermark inserted in the first media or the second media by the corresponding providers;

(3) identifying a unique bit stream pattern in the data stream that is unique to the first media or the second media (note that the identification or match does not need to be exact, merely statistically significant, because among other things, the media stream may contain errors);

(4) sending a header of information that includes the identifications and the second media locations for the particular first media; and/or

(5) a second media redirection that sends a specified number of second media in the manner, place, and electronic device determined by the media user with the time interval to report back that the second media has been consumed or otherwise used.

The users' viewers are identified by through a login (820) performed by the media player 240, 250, 260, for example, identifying a user by knowing the user has loaded an identifiable second media reporting software 285 onto their media player 240, 250, 260, or who has logged onto a web-based server to view the first and second media.

The second media reporter 490 may be part of the second media reporting software 285 or otherwise part of an integrated media manager 275. The second media reporter 490 sends the ID triplet of first media_ID, second media_ID, and user_ID (for choice preference and strategy), along with the date and time, and any user comments to the database 145 associated with a second media reporting server 320 each time first media is sent to one of the media players 240, 250, 260 and each time second media is sent to one of the media players 240, 250, 260.

The database 145 associated with a second media reporting server 320, which may be centralized or distributed, collects the information corresponding to the usage (such as viewings) of the first media and the second media. The database 145 has access to or contains the characteristics of corresponding to all three types IDs, such as: (1) a user profile, containing demographic data, viewing preferences, and inferred and collected media usage habits of each of the users, second media delivery styles, and second media formats; (2) first media descriptions, containing the media type, the content classification, and targeted viewing audience of each first media; and (3) second media descriptions, containing the media type, the second media classification, and targeted viewing audience of each second media.

A report generator 825 may utilize one or more report scripts to interrogate the database 145 and generate corresponding second media reports. These reports are tailored to, and periodically sent or available on-demand to various stakeholders, such as the first media providers and the second media providers, which may be production companies, advertisers, advertising agencies, and users. In an exemplary embodiment, each of the reports is defined by individual report scripts which will be created, modified, and updated as user or stakeholder needs may change. For example, one of the reports that can be generated is a payment distribution report, for the distribution and sharing of second media revenue, such as based on the actual number of viewings and types of viewers, which calculates the payments transferred between the stakeholders based on number of viewings, types of viewings, and the viewing audience reached by the various first media and/or the second media.

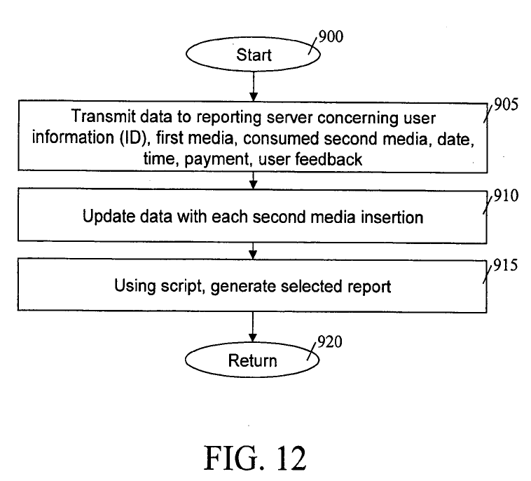

FIG. 12 is a flow diagram illustrating second media reporting in accordance with the teachings of the present invention. Beginning with start step 900, the second media reporter 490 (in a media manager 275 or second media reporting software 285) transmits data to the second media reporting server 320, step 905, concerning second media insertion, viewed/used first media, user information, and any consumer feedback, to be stored in the second media reporting server 320. This data is updated with each second media insertion, and is also stored in the second media reporting server 320 database 145, step 910. This data only needs to include the IDs of the user, the first media, the one or more second media, the date and time, the amount the user has agreed to pay or collect for the first media, and any specific feedback the user provides. It does not need to include other details concerning the user, the first media, and the second media, as this information is stored in the various MDL modules, and the specific user, first media, and second media are all identified by their respective IDs. In the event that the user's details are stored locally within his/her player, then the on-line user database 145 associated with the on the user server 255 is synchronized and updated to remain current. (Previous versions also may be archived and remain available by their date and time stamps.)

When a standard (or fixed) or a custom report is requested, such as by a user, by a first media provider, by a second media provider, or to be generated automatically (e.g., a periodic report, such as a monthly report), the report generator 825 (operating offline or online) commences operation, using corresponding scripts to generate a corresponding report type, step 915. Such reports may be electronic or digital, printed or mailed reports, using any selected format, such as XML, HTML, text, etc. In exemplary embodiments, additional scripts are provided to generate payment reports and billings for users of the system, such as using the report generator 825 in an offline mode to generate corresponding reports, including a user payment/billing script to issue payments (micro-payments) or bills for paid viewings to the users; a second media billing script to issue bills for consumer (e.g., viewed) second media; and a first media provider payment script for paying for consumer (e.g., viewed) first media. Custom report scripts may be generated as necessary or advisable. These can be generated manually, generated manually using tools, or even generated automatically by a user using online or offline tools that incorporate security features and checks to limit access to personal information of other users. Following report generation, the method may end, return step 920.

Those of skill in the art will recognize that there are innumerable reporting methodologies which may be utilized equivalently within the system 200, any and all of which are considered to be within the scope of the present invention.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment of the present invention and not necessarily in all embodiments, and further, are not necessarily referring to the same embodiment. Furthermore, the particular features, structures, or characteristics of any specific embodiment of the present invention may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

It will also be appreciated that one or more of the elements depicted in the Figures can also be implemented in a more separate or integrated manner, or even removed or rendered inoperable in certain cases, as may be useful in accordance with a particular application. Integrally formed combinations of components are also within the scope of the invention, particularly for embodiments in which a separation or combination of discrete components is unclear or indiscernible. In addition, use of the term “coupled” herein, including in its various forms such as “coupling” or “couplable”, means and includes any direct or indirect electrical, structural or magnetic coupling, connection or attachment, or adaptation or capability for such a direct or indirect electrical, structural or magnetic coupling, connection or attachment, including integrally formed components and components which are coupled via or through another component.

Furthermore, any signal arrows in the drawings/Figures should be considered only exemplary, and not limiting, unless otherwise specifically noted. Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

It is claimed:

1. A media delivery system comprising:
a first media processor adapted to determine a plurality of second media locations within a first media and to determine characteristics and requirements corresponding to the first media;
a first media server coupled to the first media processor and adapted to provide a selected first media of a plurality of first media;
a first memory coupled to the first media server and the first media processor and adapted to store, for each first media of the plurality of first media, a first module of corresponding characteristics, requirements, and the plurality of second media locations within the first media;
a second media processor adapted to determine a second media description and requirements;
a second media server adapted to provide a plurality of second media;
a second memory coupled to the second media server and the second media processor and adapted to store, for each second media of the plurality of second media, a second module of corresponding characteristics and requirements;
a third memory adapted to store, for a plurality of users, a third module of corresponding second media preferences and strategies;
a user server coupled to the third memory and adapted to provide, for a selected user of the plurality of users, corresponding second media preferences and strategies; and
a media management server couplable to the first media server, the second media server, and the user server, the media manager adapted to determine, using the corresponding second media preferences and strategies of a selected user, corresponding second media, and to provide for a transmission of selected first media and the corresponding second media to a media player of the selected user.

2. The system of claim 1, wherein the media management server is further adapted to provide the selected first media as a first media packet stream and to provide separately the corresponding second media as a second media packet stream.

3. The system of claim 1, wherein the media management server is further adapted to provide a combined first and second media packet stream comprising the first media and the corresponding second media embedded in the first media at least some of the determined plurality of second media locations.

4. The system of claim 1, wherein the first media processor is further adapted to remove pre-existing second media from the first media.

5. The system of claim 1, wherein the first media processor is further adapted to determine the plurality of second media locations from scene changes, audio level changes, premarking, and manual marking.

6. The system of claim 1, wherein the first module, the second module, and the third module are each formatted using a compatible, searchable and extendable mark up language.

7. The system of claim 1, wherein the media management server is further adapted to search and match the second media preferences and strategies of the third module to the characteristics and requirements of the first media and the second media of the respective first and second modules.

8. The system of claim 1, further comprising:
a second media reporting server adapted to determine and store, for each user of a plurality of users, corresponding second media viewing, usage or consumption.

9. The system of claim 1, wherein the second media reporting server is further adapted to determine, for each user and for each first or second media provider, corresponding payment, billing, and credit information.

10. The system of claim 1, further comprising:
a media manager adapted to determine playback or fast forwarding of second media by comparing a view pointer location and a send pointer location.

11. A tangible medium storing computer-readable and executable software instructions, comprising:
a first program construct adapted to determine and store as a corresponding first module, for each first media of a plurality of first media, a plurality of second media locations within the first media and characteristics and requirements corresponding to the first media;
a second program construct adapted to determine and store as a corresponding second module, for each second media of a plurality of second media, a second media description and requirements;
a third program construct adapted to determine and store as a corresponding third module, for each user of a plurality of users, corresponding second media preferences and strategies; and
a fourth program construct adapted to determine, using the corresponding second media preferences and strategies of a selected user, corresponding second media, and to provide for a transmission of a selected first media and the corresponding second media.

12. The tangible medium storing computer-readable and executable software instructions of claim 11, wherein the fourth program construct is further adapted to provide the selected first media as a first media packet stream and to provide separately the corresponding second media as a second media packet stream, and is further adapted to provide a combined first and second media packet stream comprising the first media and the corresponding second media embedded in the first media at least some of the determined plurality of second media locations.

13. The tangible medium storing computer-readable and executable software instructions of claim 11, wherein the first program construct is further adapted to remove pre-existing second media from the first media and to determine the plurality of second media locations from scene changes, audio level changes, premarking, and manual marking.

14. The tangible medium storing computer-readable and executable software instructions of claim 11, wherein the first module, the second module, and the third module are each formatted using a compatible, searchable and extendable mark up language.

15. The tangible medium storing computer-readable and executable software instructions of claim 11, wherein the fourth program construct is further adapted to search and match the second media preferences and strategies of the third module to the characteristics and requirements of the first media and the second media of the respective first and second modules.

16. The tangible medium storing computer-readable and executable software instructions of claim 11, further comprising:
a fifth program construct adapted to determine and store, for each user of a plurality of users, corresponding second media viewing, usage or consumption.

17. The tangible medium storing computer-readable and executable software instructions of claim 11, further comprising:
a sixth program construct adapted to determine, for each user and for each first or second media provider, corresponding payment, billing, and credit information.

18. A media delivery and reporting method, comprising:
determining and storing as a corresponding first module, for each first media of a plurality of first media, a plurality of second media locations within the first media and characteristics and requirements corresponding to the first media;
determining and storing as a corresponding second module, for each second media of a plurality of second media, a second media description and requirements;
determining and storing as a corresponding third module, for each user of a plurality of users, corresponding second media preferences and strategies;
formatting the first module, the second module, and the third module using a compatible, searchable and extendable mark up language;
determining corresponding second media for a selected user by searching and matching the second media preferences and strategies of the third module corresponding to the selected user to the characteristics and requirements of the first media and the second media of the respective first and second modules; and
transmitting selected first media and the corresponding second media in the form of either at least two separate media packet streams, or as a combined first and second media packet stream comprising the first media and the corresponding second media embedded in the first media at least some of the determined plurality of second media locations.

19. The method of claim 18, further comprising:
determining and storing, for each user of a plurality of users, corresponding second media viewing, usage or consumption.

20. The method of claim 18, further comprising:
determining and storing, for each user and for each first or second media provider, corresponding payment, billing, and credit information.
